(19) United States
(12) Patent Application Publication
(10) Pub. No.: US 2016/0004110 A1
(43) Pub. Date: Jan. 7, 2016

(54) DISPLAY PANEL AND METHOD OF PRODUCING DISPLAY PANEL

(71) Applicant: SHARP KABUSHIKI KAISHA, Osaka-shi, Osaka (JP)

(72) Inventors: Akihiro IMAI, Osaka-shi (JP); Masaki ITO, Osaka-shi (JP); Masao YAMAGUCHI, Osaka-shi (JP); Yosuke MORI, Osaka-shi (JP); Kengo HASHIMOTO, Osaka-shi (JP); Makoto KANBE, Osaka-shi (JP)

(73) Assignee: Sharp Kabushiki Kaisha, Osaka-shi, Osaka (JP)

(21) Appl. No.: 14/771,510

(22) PCT Filed: Feb. 20, 2014
(86) PCT No.: PCT/JP2014/053974

§ 371 Date: Aug. 31, 2015

(30) Foreign Application Priority Data
Mar. 22, 2013 (JP) 2013-060721

(51) Int. Cl. G02F 1/1339; G02F 1/1341

(52) U.S. Cl. CPC G02F 1/1339; G02F 1/1341; G02F 2001/13415

(57) ABSTRACT

A liquid crystal panel includes a first board, a second board, a sealing member, a first inner limiting portion, and a first outer limiting portion. The second board is disposed opposite the first board with internal space therebetween. The sealing member is disposed between the first and the second boards so as to surround and seal the internal space. The inner limiting portion is included in at least one of the first and the second boards and located closer to the internal space than the sealing member for limiting a forming area of the sealing member from an internal space side. The outer limiting portion is included in at least one of the first and the second boards and located on an outer side farther from the internal space than the sealing member for limiting the forming area of the sealing member from the outer side.

### TECHNICAL FIELD

The present invention relates to a display panel and a method of producing the display panel.

### BACKGROUND ART

A known liquid crystal panel that is a main component of a liquid crystal display device has the following configuration. The liquid crystal panel includes liquid crystals held between a pair of glass boards. A sealing member is formed around the liquid crystals to seal the liquid crystals. One of the boards is an array board including TFTs that are switching components, pixel electrodes, and traces. The other board is a CF board including color filters. An example of such a liquid crystal panel that has been known is disclosed in Patent Document 1.

The liquid crystal panel disclosed inn Patent Document 1 includes column-shaped spaces disposed in a sealant application area and a wall-shaped spacer disposed along an inner surface of the sealing member. With those, the sealing member is less likely to shrink due to atmospheric pressure after produced by a one drop filling method.

### RELATED ART DOCUMENT

### Patent Document

Patent Document 1: Japanese Unexamined Patent Application Publication No. 2013-3305

### Problem to be Solved by the Invention

The sealing member may be formed on one of the boards using a sealant dispenser in the production of the liquid crystal panel by the one drop filling method. An amount of sealant for forming the sealing member on the board may vary according to individual specificity the sealant dispenser or temperature conditions. If an excessive amount of material is supplied, the sealing member may have a wide portion, a width of which is larger than a designed width. If the amount of sealant is smaller, the sealing member may have a narrow portion, a width of which is smaller than designed. The technology disclosed in Patent Document 1 is not able to reduce such variations in width of the sealing member.

If the sealing member includes the wide portion, the material of the sealing member may flow into a display area. As a result, display quality may decrease. In production of the boards that are prepared from a base board, if the wide portion of the sealing member has reached a cutting line between the boards, cutting for preparing the boards may become difficult. If the sealing member includes the narrow portion, the narrow portion may have a higher moisture transmission rate. Namely, moisture is more likely to enter the liquid crystals via the narrow portion. A charged voltage at the pixel electrode may drop and the display quality may decrease. If non-scanning driving (or low-frequency driving) is performed for halting scanning of the gate lines for a certain period to display a still image on the liquid crystal panel, the decrease in display quality resulting from the voltage drop of the pixel electrode due to the moisture tends to be more significant.

### DISCLOSURE OF THE PRESENT INVENTION

The present invention was made in view of the foregoing circumstances. An object of the present invention is to stabilize a sealing member forming area.

### Means for Solving the Problem

A display panel according to the present invention includes a first board, a second board, a sealing member, an inner limiting portion, and an outer limiting portion. The second board is disposed opposite the first board with internal space between the first board and the second board. The sealing member is disposed between the first board and the second board so as to surround the internal space. The sealing member seals the internal space. The inner limiting portion is included in at least one of the first board and the second board. The inner limiting portion is located closer to the internal space than the sealing member. The inner limiting portion is for limiting a sealing member forming area from an internal space side. The outer limiting portion is included in at least one of the first board and the second board. The outer limiting portion is located on an outer side farther from the internal space than the sealing member. The outer limiting portion is for limiting the sealing member forming area from the outer side.

The internal space is between the first board and the second board that are opposite to each other. The sealing member is disposed so as to surround the internal space. The internal space is sealed with the sealing member. During formation of the sealing member, an amount of material of the sealing member supplied to at least one of the first board and the second board may vary according to individual specificity of a machine that supplies the material or temperature conditions. If an amount of material of the sealing member to be supplied is set larger than a normal amount, an actual amount of supplied material of the sealing member is less likely to be short. The sealing member forming area is less likely to become smaller than designed. Therefore, moisture is less likely to enter from the outside to the internal space through the sealing member and thus display quality is less likely to decrease.

If the amount of material of the sealing member to be supplied is set larger as described above, an excessive amount of material of the sealing member may be supplied. However, the sealing member forming area is limited by the inner limiting portion located closer to the internal space and the outer limiting portion located on the outer side farther from the internal space. Therefore, the sealing member forming area is less likely to become larger than designed. Namely, the sealing member forming area is less likely to expand toward the inner space. Therefore, the display quality is less likely to decrease. The sealing member forming area is less likely to expand toward the outside. Therefore, the appearance of the display panel is less likely to degrade. Furthermore, in a production process of the display panel, cutting of a base board for preparing multiple display panels therefrom by cutting it is properly performed.

Preferable embodiments may include the following configurations.

(1) The inner limiting portion and the outer limiting portion may be arranged so as to be in contact with the sealing member. According to the configuration, the sealing member forming area is properly limited.

(2) The display panel may further include at least one of a second inner limiting portion and a second outer limiting portion. The second inner limiting portion may be included in at least one of the first board and the second board and located on the internal space side in a distance from the inner limiting portion. The second outer limiting portion may be included in at least one of the first board and the second board located on the outer side in a distance from the outer limiting portion. According to the configuration, even if the excessive amount of material of the sealing member is supplied during the formation of the sealing member, the excessive material of the sealing member is released to at least space between the inner limiting portion and the second inner limiting portion or space between the outer limiting portion and the second outer limiting portion. Specifically, if the display panel includes the second inner limiting portion, the excessive material is released to the space between the inner limiting portion and the second inner limiting portion. Furthermore, a leak of the material to the internal space is restricted by the second inner limiting portion. Therefore, the display quality is less likely to decrease. If the display panel includes the second outer limiting portion, the excessive material is released to the space between the outer limiting portion and the second outer limiting portion. Furthermore, a leak of the material to the outside farther from the internal space is restricted by the second outer limiting portion. Therefore, the appearance of the display panel is less likely to degrade. Furthermore, in the production process of the display panel, cutting of the base board for preparing multiple display panels therefrom by cutting it is properly performed.

(3) At least one of the second inner limiting portion and the second outer limiting portion may be arranged parallel to the sealing member for an entire periphery of the sealing member. According to the configuration, even if the excessive amount of material of the sealing member is supplied during the formation of the sealing member, a leak of the excessive material of the sealing member to the internal space or the outside farther from the internal space is properly restricted by at least one of the second inner limiting portion and the second outer limiting portion that are arranged parallel to the sealing member for the entire periphery of the sealing member.

(4) At least one of the second inner limiting portion and the second outer limiting portion may include sections arranged at intervals in a peripheral direction of the sealing member. According to the configuration, even if the excessive amount of material of the sealing member is supplied during the formation of the sealing member, the excessive material is smoothly released to the space between the inner limiting portion and the second inner limiting portion or the space between the outer limiting portion and the second outer limiting portion through openings of at least one of the inner limiting portion and the outer limiting portion including the sections arranged at intervals in the peripheral direction of the sealing member.

(5) The sealing member may contain at least a curing resin and spacer particles. At least one of the inner limiting portion and the outer limiting portion may include an opening that opens toward the internal space and the outer side and have an opening width larger than a diameter of the spacer particles. Because the opening width of the opening formed in at least one of the inner limiting portion and the outer limiting portion is larger than the diameter of the spacer particles, if the excessive material is supplied during the formation of the sealing member, the spacer particles in the excessive material are released to the internal space or the outside through the opening. Therefore, the spacer particles are less likely to move over the inner limiting portion or the outer limiting portion and thus a distance (or a cell gap) between the first board and the second board is less likely to become uneven.

(6) At least one of the inner limiting portion and the outer limiting portion may be included in one of the first board and the second board such that a gap is provided between the at least one of the inner limiting portion and the outer limiting portion and another one of the boards. Because at least one of the inner limiting portion and the outer limiting portion is included in one of the first board and the second board such that the gap is provided between the at least one of the inner limiting portion and the outer limiting portion and the other one of the boards, even if the excessive material is supplied during the formation of the sealing member, the excessive material of the sealing member is released to the space between the inner limiting portion and the second inner limiting portion or the space between the outer limiting portion and the second outer limiting portion.

(7) At least one of the second inner limiting portion and the second outer limiting portion may be included in at least one of the first board and the second board such that a gap is provided between the at least one of the second inner limiting portion and the second outer limiting portion and another one of the boards. If the distance between the inner limiting portion and the second inner limiting portion or the distance between the outer limiting portion and the second limiting portion is set larger, a larger amount of the excessive material of the sealing member can be released. However, an area required for the limiting portions becomes larger, that is, the frame size of the display panel becomes larger. As described above, the at least one of the second inner limiting portion and the second outer limiting portion is included in one of the first board and the second board such that the gap is provided between the at least one of the second inner limiting portion and the second outer limiting portion and the other one of the boards. Therefore, the excessive amount of material of the sealing member can be released to the space between the inner limiting portion and the second limiting portion or the space between the outer limiting portion and the second outer limiting portion at a certain upper limit even if the distance between the inner limiting portion and the second inner limiting portion or the distance between the outer limiting portion and the second outer limiting portion is not set relatively large. Only if the amount of material of the sealing member exceeds the upper limit, the excessive material is released to the internal space or the outside through the gap between at least one of the second inner limiting portion and the second outer limiting portion and the other one of the boards. Namely, the distance between the inner limiting portion and the second inner limiting portion or the distance between the outer limiting portion and the second outer limiting portion is set as small as possible. This is advantageous for reducing the frame size of the display panel.

(8) At least one of the first board and the second board may include at least a color filter, a light blocking portion, and a spacer. The color filter may include multiple color portions. The light blocking portion may be arranged between the adjacent color portions. The space may be for defining a distance between the at least one of the first board and the second board and the other one of the first board and the second board. The inner limiting portion and the outer limiting portion may be included in the one of the boards and made of same material as that of at least one of the color filter, the light blocking portion, and the spacer. The inner limiting portion and the outer limiting portion may be made of the same material as that of the color filter, the light blocking portion, and the spacer that are originally included in the one of the boards. According to the configuration, the cost required for forming the inner limiting portion and the outer limiting portion in the one of the boards can be reduced.

(9) The inner limiting portion and the outer limiting portion may be included in one of the first board and the second board. The sealing member may contain at least a curing resin and spacer particles. The other one of the first board and the second board may include a spacer holding groove for holding the spacer particles therein at a portion that is in contact with the sealing member. If the excessive amount of material is supplied during the formation of the sealing member, the spacer particles in the excessive material of the sealing member are released to the spacer holding groove formed in the portion of the other one of the first board and the second board in contact with the sealing member and in which the inner limiting portion and the outer limiting portion are formed. According to the configuration, the spacer particles are less likely to move over the inner limiting portion or the outer limiting portion. Therefore, the distance (the cell gap) between the first board and the second board is less likely to be uneven.

(10) Any one of the first board and the second board may include at least a switching component that uses an oxide semiconductor as a semiconductor film and a pixel electrode connected to the switching component. Because the oxide semiconductor is used for the semiconductor film of the switching component, in comparison to a configuration in which amorphous silicon is used for the semiconductor film, an off-leak current of the switching component is small. A high voltage retaining rate of the pixel electrode is achieved. This is advantageous for non-scanning driving (low-frequency driving) during display of a still image. If moisture enters from the outside to the internal space through the sealing member, a leak current from the pixel electrode tends to increase due to the moisture. As a result, a voltage of the pixel electrode charged through the switching component tends to drop during the non-scanning driving. With the inner limiting portion and the outer limiting portion, the sealing member forming area is less likely become smaller than designed. Therefore, the moisture is less likely to enter from the outside to the internal space via the sealing member and thus the voltage drop of the pixel electrode due to the moisture is less likely to occur. According to the configuration, the display quality is maintained at a high level.

(11) The oxide semiconductor may contain indium (In), gallium (Ga), zinc (Zn), and oxygen (O) as base components. According to the configuration, the off-leak current of the switching component can be further reduced and thus the voltage retaining rate of the pixel electrode increases. This is further advantageous for the non-scanning driving (the low-frequency driving) during the display of a still image.

(12) The display panel may further include liquid crystals in the internal space between the first board and the second board. The liquid crystals in the internal space between the first board and the second board that are opposite to each other are sealed with the sealing member that surrounds the internal space.

A method of producing a display panel according to the present invention includes a limiting portion forming process, a sealing member forming process, and a bounding process. The limiting portion forming process is for forming an inner limiting portion in any one of a first board and a second board closer to an internal space and an outer limiting portion on an outer side farther from the internal space. The sealing member forming process is for forming a sealing member between the inner limiting portion and the outer limiting portion on the one of the boards. The bonding process is for bonding another one of the first board and he second board opposite the one of the boards to the one of the boards with the internal space therebetween.

In the limiting portion forming process, the inner limiting portion and the outer limiting portion are formed in one of the first board and the second board. In the sealing member forming process, the sealing member is formed between the inner limiting portion and the outer limiting portion that are formed in the one of the boards in advance. Therefore, a sealing member forming area is formed is properly limited by the inner limiting portion and the outer limiting portion. In the bonding process, the other one of the first board and the second board is bonded to the one of the boards such that the boards are opposite to each other with the internal space therebetween. As a result, the inner space is sealed with the sealing member.

In the sealing member forming process, the amount of material of the sealing member supplied to the one of the boards may vary according to individual specificity of a machine that supplies the material or temperature conditions. If the amount of material of the sealing member to be supplied is set larger than a normal amount, the actual amount of supplied material of the sealing member is less likely to be short. Namely, the sealing member forming area is less likely to become smaller than designed. Therefore, the moisture is less likely to enter from the outside to the internal space and thus the display quality is less likely to decrease.

If the amount of material of the sealing member to be supplied is set as described above, the excessive amount of material of the sealing member may be supplied. In this case, the sealing member forming area is limited by the inner limiting portion located closer to the internal space and the outer limiting portion located on the outer side farther from the internal space. Therefore, the sealing member forming area is less likely to expand toward the internal space and thus the display quality is less likely to decrease. The sealing member forming area is less likely to expand toward the outside farther from the internal space. Therefore, the appearance of the display panel is less likely to degrade. Furthermore, in the production process of the display panel, cutting of the base board for preparing multiple display panels therefrom is properly performed.

Preferable embodiments of the method of producing the display panel may include the following.

(1) The sealing portion forming process may include supplying a material of the sealing member to the one of the boards at an amount such that a sealing member forming area is larger than a distance between the inner limiting portion and the outer limiting portion. In the sealing member forming process, because the material of the sealing member to the one of the boards at the amount such that the sealing member forming area is larger than a distance between the inner limiting portion and the outer limiting portion, even if the actual supplied amount is smaller than the set amount due to the individual specificity of the machine that supplies the material or the temperature conditions, the material of the sealing member is further less likely to be short. Because the sealing member forming area is less likely to become smaller than designed, the moisture is less likely to enter from the outside to the internal space through the sealing member and thus the display quality is less likely to decrease.

### Advantageous Effect of the Invention

According to the present invention, the sealing member forming area is stabilized.

### BRIEF DESCRIPTION OF THE DRAWINGS

FIG. 1 is a schematic plan view of a liquid crystal panel with a driver mounted thereon, a flexible printed circuit board, and a control circuit board according to a first embodiment of the present invention illustrating connection thereamong.

FIG. 2 is a schematic cross-sectional view of a liquid crystal display device illustrating a cross-sectional configuration along a long-side direction thereof.

FIG. 3 is a schematic cross-sectional view illustrating a cross-sectional configuration of the liquid crystal panel.

FIG. 4 is a schematic cross-sectional view illustrating a cross-sectional configuration of a display area of the liquid crystal panel.

FIG. 5 is a plan view of pixels in a display area of an array board included in the liquid crystal panel.

FIG. 6 is a cross-sectional view along line vi-vi in FIG. 5.

FIG. 7 is a signal waveform of scan signals for an explanation of non-scanning driving with a refresh rate of 1 Hz.

FIG. 8 is a plan view of a CF board included in the liquid crystal panel.

FIG. 9 is a magnified plan view of a sealing member and limiting portions in FIG. 8.

FIG. 10 is a cross-sectional view along line x-x in FIG. 9.

FIG. 11 is a magnified cross-sectional view of FIG. 10.

FIG. 12 is a cross-sectional view illustrating a state after an OC layer is formed on the CF board and before spacers and the limiting portions are formed.

FIG. 13 is a cross-sectional view illustrating a state after the spacers and the limiting portions are formed on the CF board.

FIG. 14 is a cross-sectional view illustrating a state after a material of a sealing member is applied to the CF board and liquid crystals are dropped and before the array board is bonded.

FIG. 15 is a cross-sectional view illustrating a state after the array board is bonded to the CF board.

FIG. 16 is a plan view illustrating a state before liquid crystal panels are prepared from a panel base board.

FIG. 17 is a magnified plan view of a sealing member and limiting portions according to a second embodiment of the present invention.

FIG. 18 is a cross-sectional view illustrating spacer holding grooves formed in an organic insulator of an array board according to a third embodiment of the present invention.

FIG. 19 is a plan view illustrating the spacer holding grooves formed in the organic insulator of the array board.

FIG. 20 is a cross-sectional view illustrating a sealing member and limiting members according to a fourth embodiment of the present invention.

FIG. 21 is a cross-sectional view illustrating a sealing member and limiting members according to a fifth embodiment of the present invention.

FIG. 22 is a cross-sectional view illustrating a sealing member and limiting members according to a sixth embodiment of the present invention.

FIG. 23 is a cross-sectional view illustrating a sealing member and limiting members according to a seventh embodiment of the present invention.

FIG. 24 is a magnified plan view of a sealing member and limiting members according to an eighth embodiment of the present invention.

FIG. 25 is a magnified plan view of a sealing member and limiting members according to a ninth embodiment of the present invention.

FIG. 26 is a magnified plan view of a sealing member and limiting members according to an eighth embodiment of the present invention.

FIG. 27 is a magnified plan view of a sealing member and limiting members according to an eleventh embodiment of the present invention.

FIG. 28 is a magnified plan view of a sealing member and limiting members according to a twelfth embodiment of the present invention.

FIG. 29 is a magnified plan view of a sealing member and limiting members according to a thirteenth embodiment of the present invention.

FIG. 30 is a magnified plan view of a sealing member and limiting members according to a fourteenth embodiment of the present invention.

FIG. 31 is a magnified plan view of corners of a sealing member and limiting members according to a fifteenth embodiment of the present invention.

FIG. 32 is a cross-sectional view of a spacer holding portion formed in an organic insulator of the array board according to a sixteenth embodiment of the present invention.

FIG. 33 is a plan view of spacer holding portions formed in the organic insulator of the array board.

FIG. 34 is a cross-sectional view of a sealing member and limiting members according to modification (1) of the present invention.

FIG. 35 is a cross-sectional view of a sealing member and limiting members according to modification (2) of the present invention.

FIG. 36 is a cross-sectional view of a sealing member and limiting members according to modification (3) of the present invention.

FIG. 37 is a cross-sectional view of a sealing member and limiting members according to modification (4) of the present invention.

FIG. 38 is a cross-sectional view of a sealing member and limiting members according to modification (5) of the present invention.

FIG. 39 is a cross-sectional view of a sealing member and limiting members according to modification (6) of the present invention.

FIG. 40 is a cross-sectional view of a sealing member and limiting members according to modification (7) of the present invention.

### MODE FOR CARRYING OUT THE INVENTION

### First Embodiment

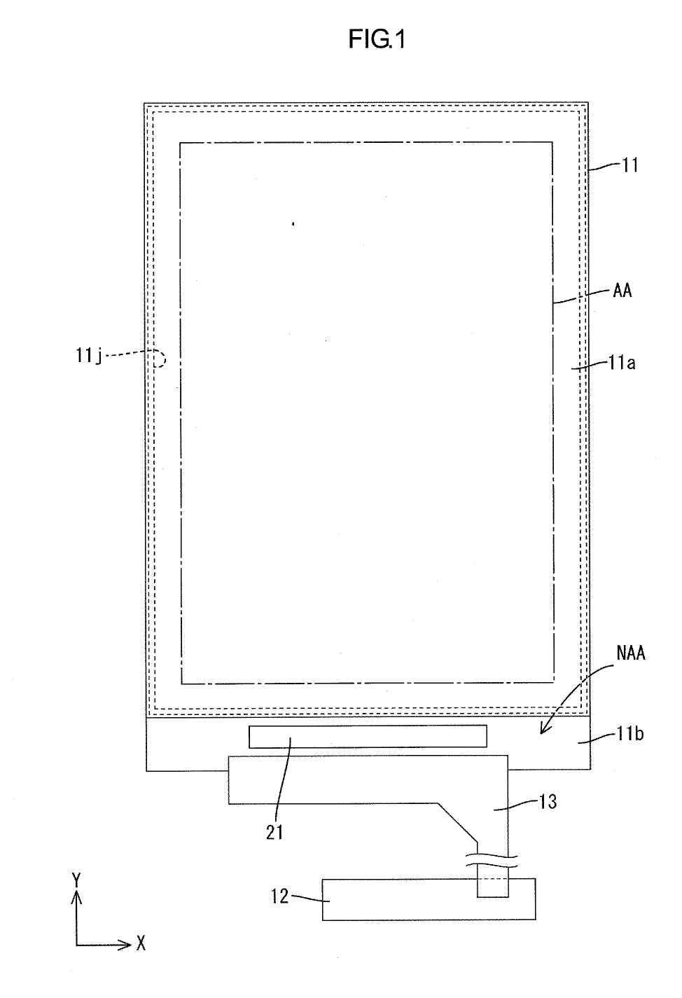

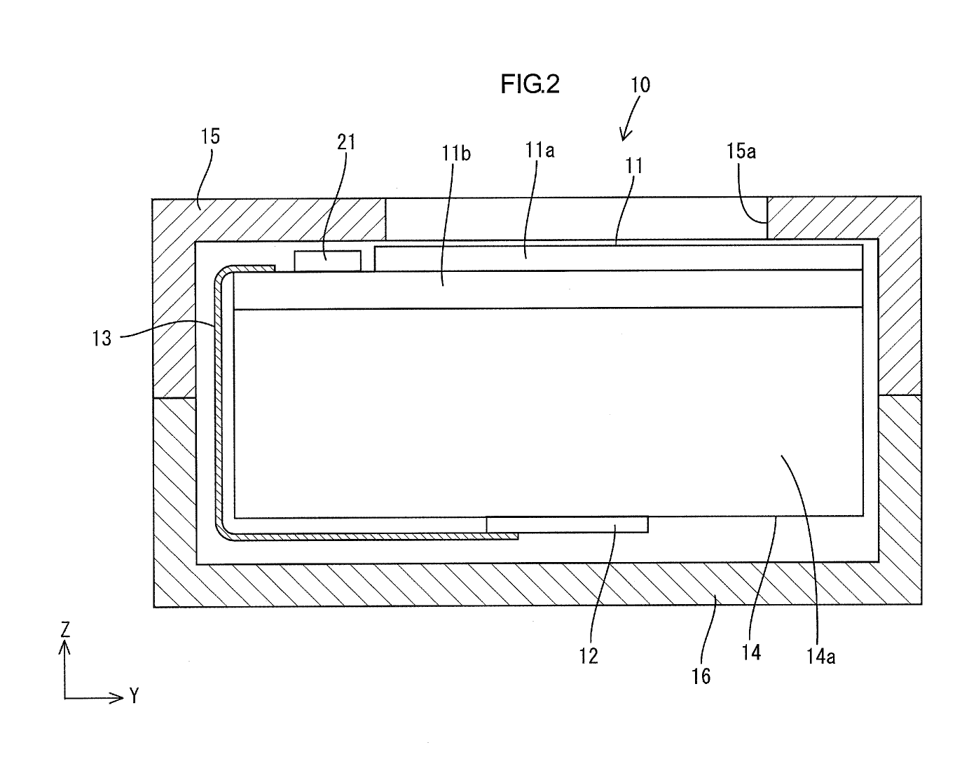

A first embodiment of the present invention will be described with reference to FIGS. 1 to 14. A liquid crystal display device 10 will be described as an example. X-axis, the Y-axis and the Z-axis may be present in the drawings. The axes in each drawing correspond to the respective axes in other drawings. The vertical direction is defined based on FIG. 2. An upper side and a lower side in FIG. 2 correspond to a front side and the back side of the liquid crystal display device 10, respectively.

As illustrated in FIGS. 1 and 2, a liquid crystal display device 10 includes a liquid crystal panel (a display device, a display panel) 11, a driver (a panel driver) 21, a control circuit board (an external signal source) 12, a flexible printed circuit board (an external connecting component) 13, and a backlight unit (a lighting device) 14. The liquid crystal panel 11 includes a display area AA and a non-display area NAA around the display area AA. The display area AA is an inner area configured to display images. The driver 21 is configured to drive the liquid crystal panel 11. The control circuit board 12 is configured to supply various input signals from the outside to the driver 21. The flexible printed circuit board 13 electrically connects the liquid crystal panel 11 to the external control circuit board 12. The backlight unit 14 is an external light source configured to supply light to the liquid crystal panel 11. The liquid crystal display device 10 further includes a pair of exterior components 15 and 16 that are front and rear components used in a pair to hold the liquid crystal panel 11 and the backlight unit 14 that are attached together. The exterior component 15 on the front side has an opening 15a through which images displayed in the display area AA of the liquid crystal panel 11 are viewed from the outside. The liquid crystal display device 10 according to this embodiment may be used in various kinds of electronic devices (not illustrated) such as mobile phones (including smartphones), laptop computers (tablet computers), handheld terminals (electronic books and PDAs), digital photo frames, portable video game players, and electronic-ink papers. The liquid crystal panel 11 in the liquid crystal display device 10 is in a range between some inches to ten and some inches. Namely, the liquid crystal panel 11 is in a size that is classified as a small or a small-to-medium.

The backlight unit 14 will be briefly described. As illustrated in FIG. 2, the backlight unit 14 includes a chassis 14a, light sources (e.g., cold cathode fluorescent tubes, LEDs, organic ELs), and an optical member. The chassis 14a has a box-like shape with an opening on the front side (opening toward the liquid crystal panel 11). The light sources, which are not illustrated, are disposed inside the chassis 14a. The optical member, which is not illustrated, is disposed to cover the opening of the chassis 14a. The optical member has a function to convert light from the light sources into planar light.

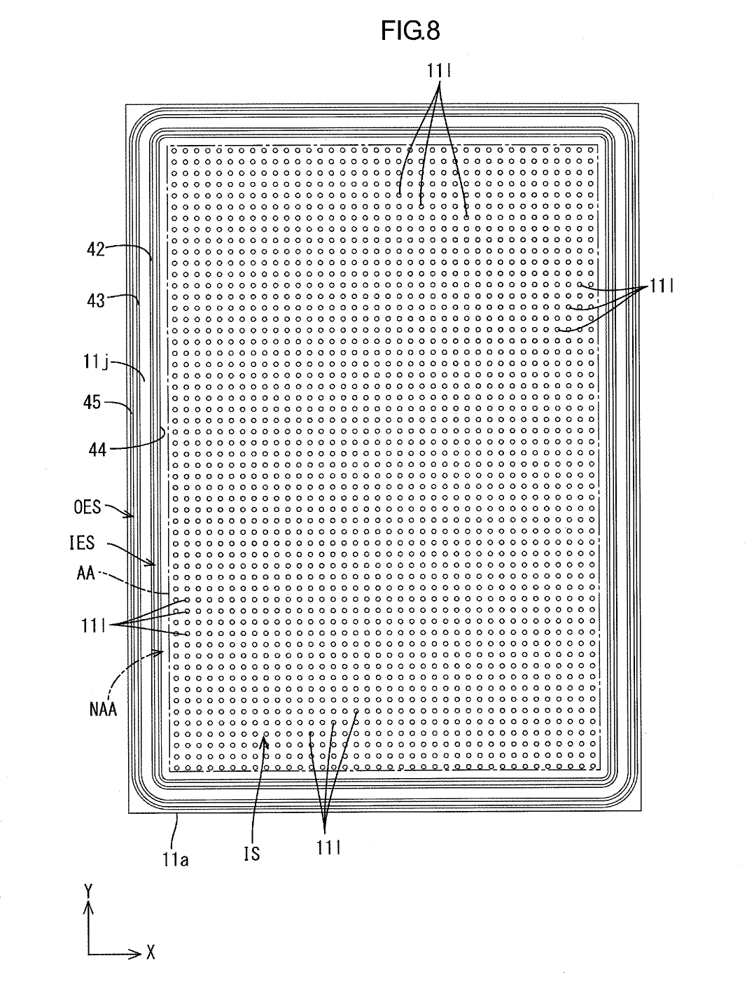

Next, the liquid crystal panel 11 will be described. As illustrated in FIG. 1, the liquid crystal panel 11 has a vertically-long rectangular overall shape (a rectangular shape). The liquid crystal panel 11 includes the display area (a display area, an active area) AA that is off centered toward one of ends of a long dimension thereof (the upper side in FIG. 1). The driver 21 and the flexible printed circuit board 13 are mounted to a portion of the liquid crystal panel 11 closer to the other end of the long dimension of the liquid crystal panel 11 (the lower side in FIG. 1). An area of the liquid crystal panel 11 outside the display area AA is a non-display area (a non-display area, a non-active area) NAA in which images are not displayed. The non-display area NAA includes a frame-shaped area around the display area AA (a frame portion of a CF board 11a, which will be described later) and an area provided at the other end of the long dimension (an exposed area of an array board 11b which does not overlap the CF board 11a and exposed, which will be described later). The area provided at the other end of the long dimension of the liquid crystal panel 11 includes a mounting area (an attachment area) to which the driver 21 and the flexible printed circuit board 13 are mounted. The short dimension of the liquid crystal panel 11 coincides with the X-axis direction of each drawing and the long dimension thereof coincides with the Y-axis direction of each drawing. In FIGS. 1 and 8, a chain line box slightly smaller than the CF board 11a indicates a boundary of the display area AA. An area outside the chain line is the non-display area NAA.

Next, the components connected to the liquid crystal panel 11 will be described. As illustrated in FIGS. 1 and 2, the control circuit board 12 is mounted to the back surface of the chassis 14a (an outer surface on a side opposite from the liquid crystal panel 11) of the backlight unit 14 with screws. The control circuit board 12 includes a substrate and electronic components. The substrate is made of paper phenol or glass epoxy resin. The electronic components are mounted on the substrate and configured to supply various input signals to the driver 21. Traces (electrically conductive paths) which are not illustrated are formed in predetermined patterns. An end (end side) of the flexible printed circuit board 13 is electrically and mechanically connected to the control circuit board 12 via an anisotropic conductive film (ACF), which is not illustrated.

The flexible printed circuit board (an FPC board) 13 includes a base member made of synthetic resin having insulating property and flexibility (e.g., polyimide resin) as illustrated in FIG. 2. A number of traces are formed on the base member (not illustrated). The end of the long dimension of the flexible printed circuit board 13 is connected to the control circuit board 12 disposed on the back surface of the chassis 14a as described above, while the other end of the long dimension of the flexible printed circuit board 13 is connected to the array board 11b in the liquid crystal panel 11. The flexible printed circuit board 13 is therefore bent or folded back inside the liquid crystal display device 10 such that a cross-sectional shape thereof forms a U-like shape. At the ends of the long dimension of the flexible printed circuit board 13, the wiring patterns are exposed to the outside and configured as terminals (not illustrated). The terminals are electrically connected to the control circuit board 12 and the liquid crystal panel 11. With this configuration, input signals supplied by the control circuit board 12 are transmitted to the liquid crystal panel 11.

As illustrated in FIG. 1, the driver 21 is provided by an LSI chip including drive circuits. The driver 21 is configured to operate according to signals supplied by the control circuit board 12 serving as a signal source, to process the input signal supplied by the control circuit board 12 to generate output signals, and to output the output signals to the display area AA in the liquid crystal panel 11. The driver 21 has a horizontally-long rectangular shape (an elongated shape that extends along the short side of the liquid crystal panel 11) in a plan view. The driver 21 is directly mounted to the non-display area NAA of the liquid crystal panel 11 (or the array board 11b, which will be described later), that is, mounted by the chip-on-glass (COG) mounting method. The long dimension and the short dimension of the driver 21 correspond to the X-axis direction (the short dimension of the liquid crystal panel 11) and the Y-axis direction (the long dimension of the liquid crystal panel 11), respectively.

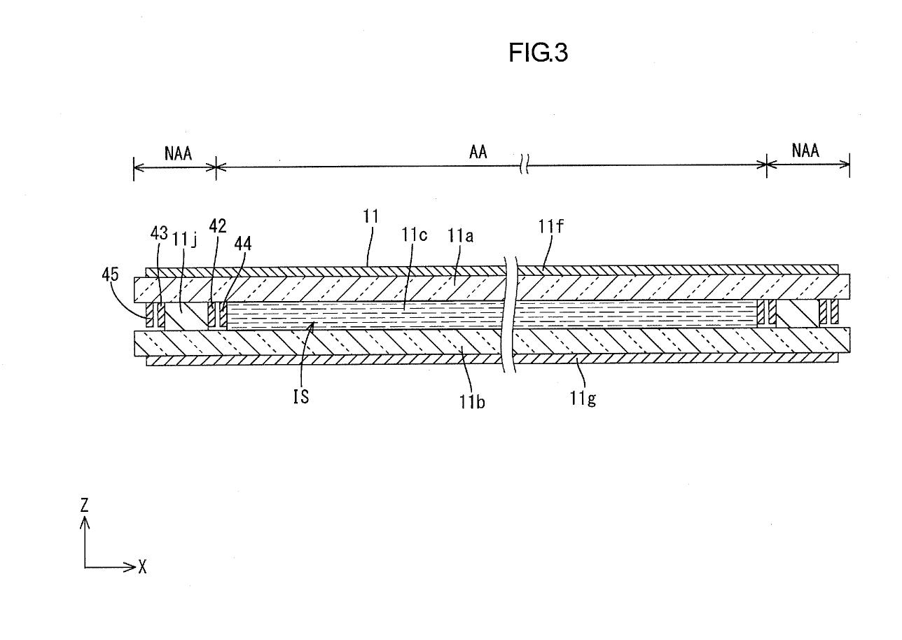

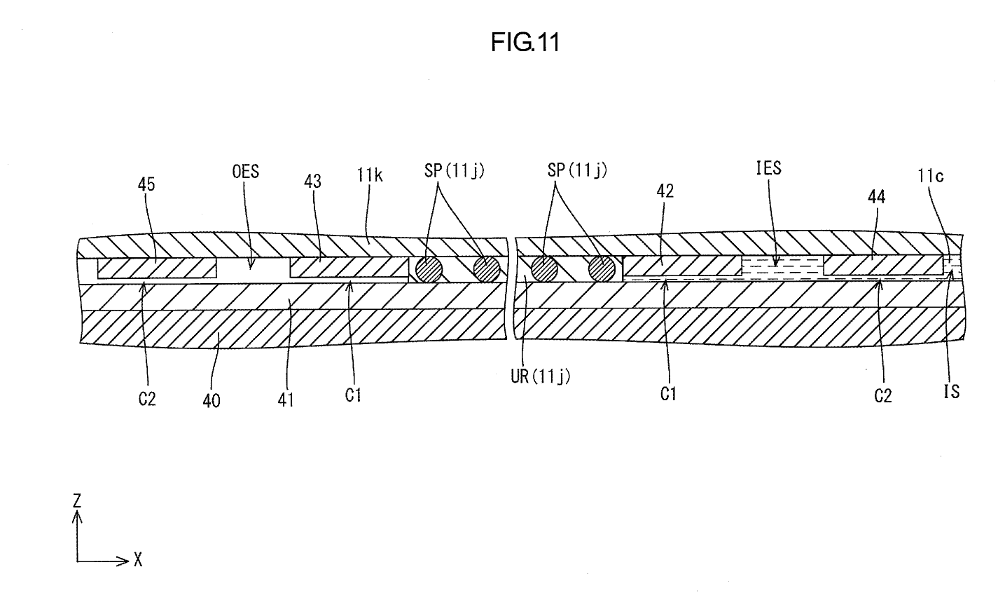

The liquid crystal panel 11 will be described in more detail. As illustrated in FIG. 3, the liquid crystal panel 11 includes at least a pair of boards (a first board and a second board) 11a and 11b, a liquid crystal layer (liquid crystals) 11c, and a sealing member 11j. The boards 11a and 11b are opposite to each other with internal space IS therebetween. The liquid crystal layer 11c is in the internal space IS between the boards 11a and 11b. The liquid crystal layer 11c includes liquid crystal molecules having optical characteristics that change according to application of the electric field. The sealing member 11j is between the boards 11a and 11b so as to surround the internal space IS and the liquid crystal layer 11c in the internal space IS. The sealing member 11j seals the internal space IS and the liquid crystal layer 11c in the internal space IS. One of the boards 11a and 11b on the front side is a CF board (one of the boards, a common board) 11a. The other one of the boards 11a and 11b on the rear side (the back side) is an array board (another one of the boards, a TFT board) 11b. The liquid crystal layer 11c is sealed between the boards 11a and 11b by a so-called one drop filling method. Liquid crystals that are material for the liquid crystal layer 11c are dropped on the CF board 11a and the array board 11b is bonded to the CF board 11a. The liquid crystal evenly spread in the internal space IS between the boards 11a and 11b. The sealing member 11j is disposed in the non-display area NAA of the liquid crystal panel 11. The sealing member 11j has a vertically-long rectangular shape along the non-display area NAA in a plan view (viewed from a direction normal to a plate surface of the array board 11b, FIG. 8). The sealing member 11j is formed on the CF board 11a of the boards 11a and 11b in the production process of the liquid crystal panel 11. With the sealing member 11j, a distance between the boards 11a and 11b (a thickness of the liquid crystal layer 11c), that is, a cell gap is maintained constant at edge areas of the boards 11a and 11b. The cell gap may be in a range from 3 μm to 3.6 μm. The sealing member 11j contains at least ultraviolet curing resin (curing resin) UR and a number of spacer particles SP (see FIG. 11). The ultraviolet curing resin UR is hardened by application of ultraviolet rays. The spacer particles SP are dispersed in the ultraviolet curing resin UR. Before the application of the ultraviolet rays, the ultraviolet curing resin UR is in the liquid state having flowability. After the application of the ultraviolet rays, the ultraviolet curing resin UR is hardened and in the solid state. Each spacer particle SP is made of synthetic resin and has a spherical shape. A predefined amount of the spacer particles (e.g., about 1 wt %) is contained in the ultraviolet curing resin UR. A diameter of each spacer particle SP is about equal to the cell gap, for example, in a range from 3 μm to 3.6 μm. Portions of the sealing member 11j arranged in edge areas (non-mounting edge areas) of the liquid crystal panel 11 along three edges other than the mounting area for the driver 21 and the flexible printed circuit board 13 are at the outermost of the non-display area NAA (FIG. 1). Polarizing plates 11f and 11g are bonded to the outer surfaces of the boards 11a and 11b, respectively.

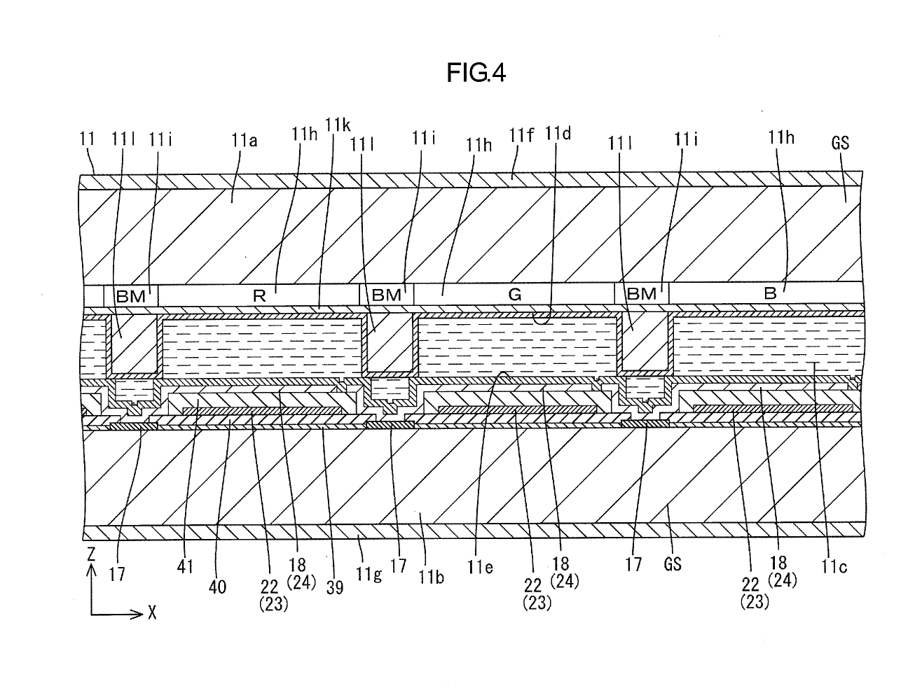

The liquid crystal panel 11 according to this embodiment operates in a fringe field switching (FFS) mode that is a mode improved from an in-plane switching (IPS) mode. As illustrated in FIG. 4, one of the pair of boards 11a and 11b, that is, the array board 11b is provided with pixel electrodes (second transparent electrodes) 18 and common electrodes (first transparent electrodes) 22, which will be described later. The electrodes 18 and the common electrodes 22 are provided in the different layers. The CF board 11a and the array board 11b each include a glass substrate GS that is substantially transparent (i.e., having high light transmissivity). Various films are formed in layers on each glass substrate GS. As illustrated in FIGS. 1 and 2, the CF board 11a has a short dimension substantially equal to that of the array board 11b and a long dimension smaller than that of the array board 11b. The CF board 11a is bonded to the array board 11b with one of ends of the long dimension (the upper end in FIG. 1) aligned with a corresponding edge of the array board 11b. A predetermined area of the other end of the long dimension of the array board 11b (the lower end in FIG. 1) does not overlap the CF board 11a and front and back plate surfaces of the area are exposed to the outside. The mounting area in which the driver 21 and the flexible printed circuit board 13 are mounted is provided in this area. Alignment films 11d and 11e are formed on inner surfaces of the boards 11a and 11b, respectively, for alignment of the liquid crystal molecules included in the liquid crystal layer 11c. The alignment films 11d and 11e are formed of, for example, polyimide, and are in solid patterns formed in a substantially whole area along the plate surfaces of the boards 11a and 11b (FIG. 4). The alignment films 11d and 11e are configured to align, by irradiation with light having a particular wavelength (for example, ultraviolet ray), the liquid crystal molecules in the irradiation direction of the light. FIG. 4 schematically illustrates structures of the boards 11a and 11b and thus dimensions (e.g., thickness, height) of the structures in the drawing do not correspond with actual dimensions of the boards 11a and 11b.

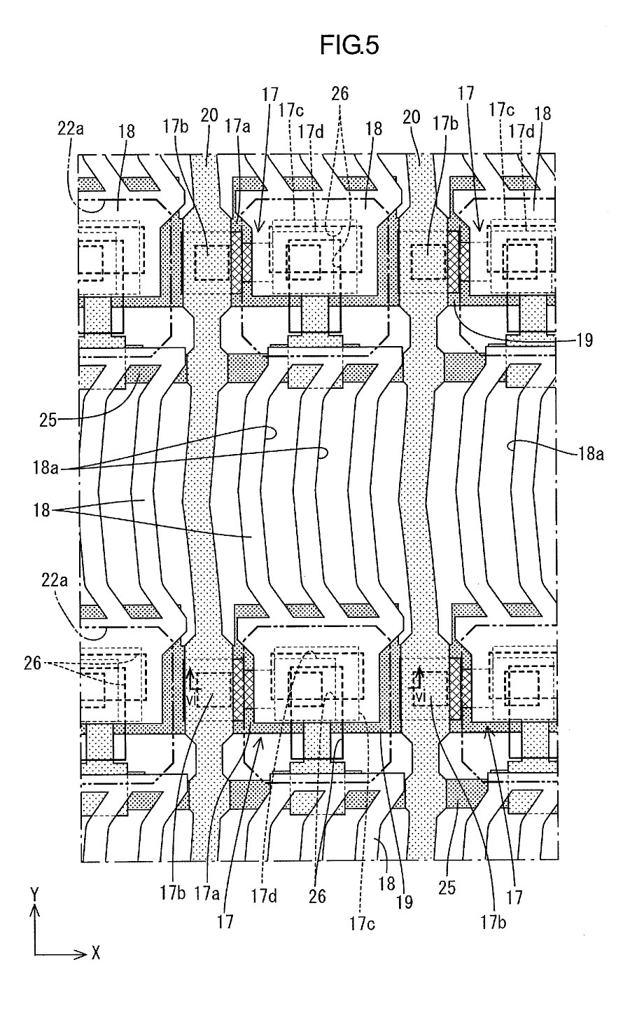

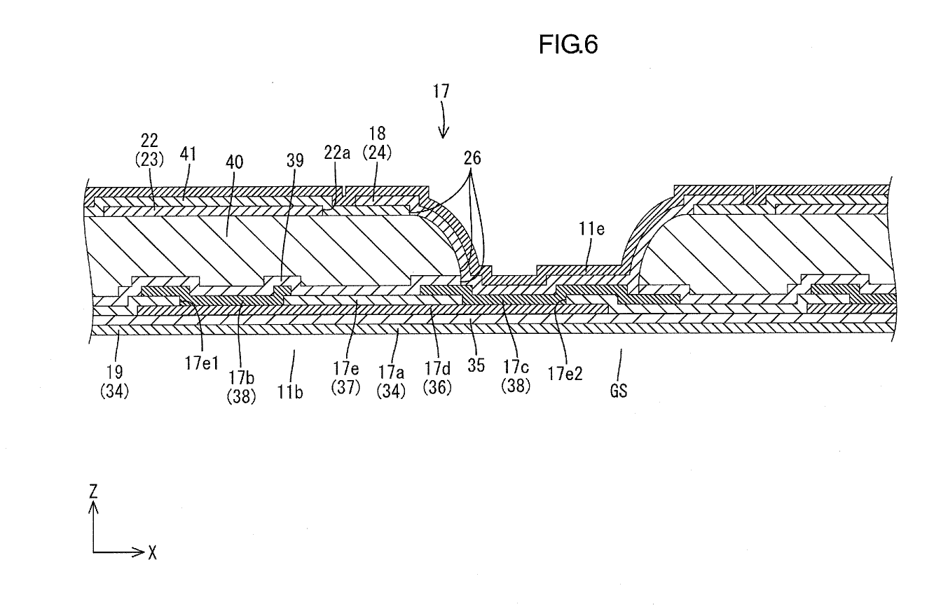

The films formed in layers on the inner surface of the array board 11b (on the liquid crystal layer 11c side, a surface opposite the CF board 11a) by a known photolithography method will be described. As illustrated in FIG. 6, on the array board 11b, the following films are formed in the following sequence from the lowest layer (the grass substrate GS): a first metal film (a gate metal film) 34, a gate insulator 35, an oxide semiconductor film 36, a protection film (an etching stopper film, and ES film) 37, a second metal film (a source metal film) 38, a first interlayer insulator (an insulator) 39, an organic insulator 40, a first transparent electrode film 23, a second interlayer insulator 41, a second transparent electrode film 24, and the alignment film 11e. In FIG. 5, the first metal film 34, the semiconductor film 36, and the second metal film 38 are illustrated with hatching.

The first metal film 34 is a multilayer film of titanium (Ti) and copper (Cu). The gate insulator 35 is formed at least above the first metal film 34 and is made of, for example, silicon oxide (SiO₂). The semiconductor film 36 is a thin film of an In—Ga—Zn—O (oxide) semiconductor (an indium gallium zinc oxide) containing indium (In), gallium (Ga), and zinc (Zn) as main components. The oxide semiconductor film, that is, the oxide semiconductor film 36 is amorphous or crystalline. The protection film 37 is made of silicon oxide (SiO₂). The second metal film 38 is a multilayer film that includes titanium (Ti) and copper (Cu). The first interlayer insulator 39 is made of silicon oxide (SiO₂). The organic insulator 40 is made of acrylic resin (e.g., polymethyl methacrylate (PMMA)), which is an organic material, and functions as a planarization film. The first transparent electrode film 23 and the second transparent electrode film 24 are made of a transparent electrode material such as indium tin oxide (ITO) or zinc oxide (ZnO). The second interlayer insulator 41 is made of silicon nitride (SiNₓ). The first transparent electrode film 23 and the second transparent electrode film 24 among these films are formed only in the display area AA of the array board 11b, and are not formed in the non-display area NAA. The insulators made of the insulating materials, such as the gate insulator 35, the protection film 37, the first interlayer insulator 39, the organic insulator 40, and the second interlayer insulator 41, are formed in solid patterns disposed in a substantially whole area of the surface of the array board 11b (although holes are formed in some areas). The first metal film 34, the oxide semiconductor film 36, and the second metal film 38 are formed in predetermined patterns in the display area AA and the non-display area NAA of the array board 11b.

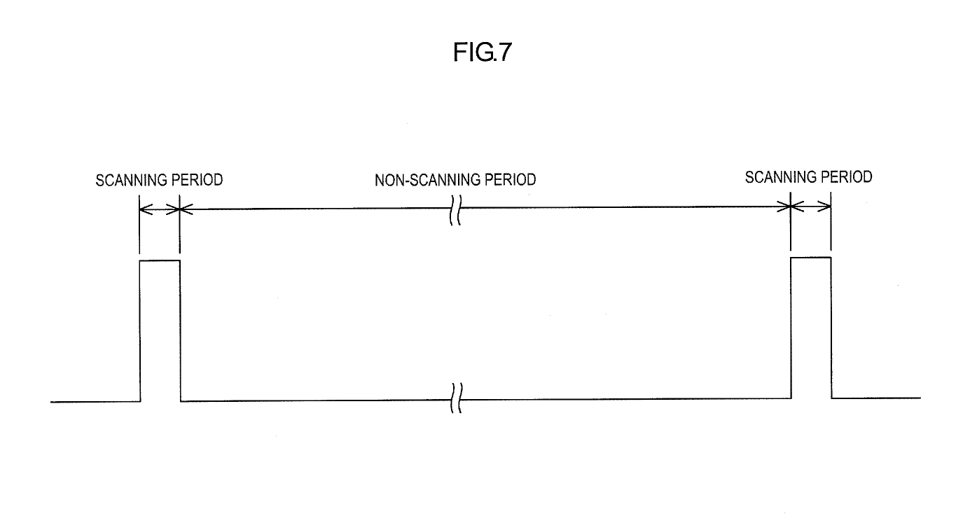

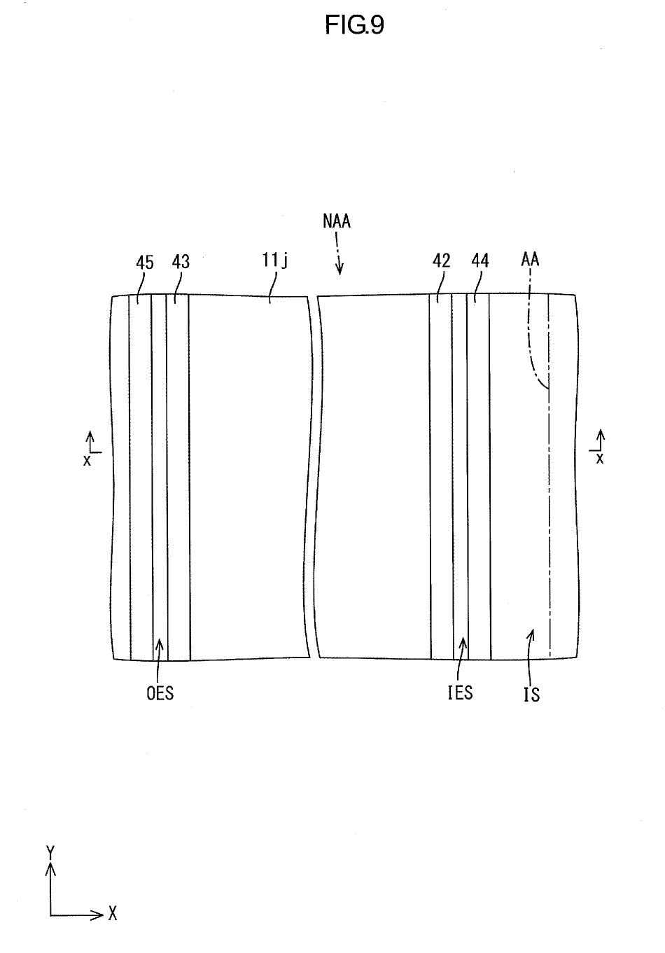

Next, configurations of components in the display area AA of the array board 11b will be described in sequence. As illustrated in FIG. 5, in the display area AA of the array board 11b, a number of TFTs (transistors) 17, which are switching components, and a number of pixel electrodes 18 are disposed in a matrix. Gate lines (scanning lines, row control lines) 19 and source lines (column control lines, data lines) 20 are routed in a matrix such that each pair of display area TFT 17 and the pixel electrode 18 is in a cell defined by the gate lines 19 and the source lines 20. Namely, the TFTs 17 and the pixel electrodes 18 are disposed in parallel to be arranged in a matrix at respective corners defined by the gate lines 19 and the source lines 20 that are formed in a matrix. The gate lines 19 are formed from the first metal film 34 and the source lines 20 are formed from the second metal film 38. The gate insulator 35 and the protection film 37 are interposed between the gate line 19 and the source line 20 at an intersection thereof. The gate lines 19 and the source lines 20 are connected to gate electrodes 17a and source electrodes 17b of the TFTs 17, respectively. The pixel electrodes 18 are connected to drain electrodes 17c of TFTs 17 (FIG. 9). The gate line 19 is disposed overlapping one end (the lower end in FIG. 7) of the pixel electrode 18 in a plan view (viewed from the normal line direction relative to the plate surface of the array board 11b). In addition, the array board 20 is provided with an auxiliary capacitor line (storage capacitor line, Cs line) 25 that is in parallel to the gate line 19 and overlaps a portion of the pixel electrode 18 in a plan view. The auxiliary capacitor line 25 is made of the same metal film 34 as the gate line 19, and is provided overlapping the other end (the upper end in FIG. 7) in the pixel electrode 18 in a plan view, i.e., on the opposite side with the center of the pixel electrode 18 interposed between the auxiliary capacitor line 25 and the gate line 19 in the Y-axis direction. In other words, the auxiliary capacitor line 25 is provided adjacent to the gate line 19 while a predetermined gap is maintained therebetween in the Y-axis direction. The gate line 19 is connected to the pixel electrode 18 adjacent to the pixel electrode 18 on the upper side overlapping the auxiliary capacitor line 25 via the TFT 17 as illustrated in FIG. 5. The auxiliary capacitor lines 25 and the gate lines 19 are alternately disposed in the Y-axis direction.

As illustrated in FIG. 8, the TFT 17 is mounted on the gate line 19, i.e., disposed entirely overlapping the gate line 19 in a plan view. A portion of the gate line 19 constitutes the gate electrode 17a of the TFT 17, and the portion of the source line 20 that overlaps the gate line 19 in a plan view constitutes the source electrode 17b of the TFT 17. The TFT 17 includes the drain electrode 17c, which has an island shape by being disposed opposite to the source electrode 17b with a predetermined gap therebetween in the X-axis direction. The drain electrode 17c is formed from the second metal film 38, which is the same as the source electrode 17b (source line 20), and is disposed overlapping one end of the pixel electrode 18 (portion where a later-described slit 18a is not formed) in a plan view. The drain electrode 17c has a drain line 29 formed from the same second metal film 38 connected thereto. The drain line 29 is extended from the connected drain electrode 17c in the Y-axis direction toward the lower side in FIG. 8, i.e., toward the auxiliary capacitor line 25, and an extension end thereof is provided with a capacitance formation portion 29a forming capacitance by overlapping the auxiliary capacitor line 25 and the next pixel electrode 18 (specifically, the pixel electrode 18 adjacent to and below the pixel electrode 18 connected to the drain electrode 17c in FIG. 8) in a plan view. The portion of the gate line 19 not overlapping the source line 20 in a plan view is formed to have a larger line width than the portion overlapping the source line 20 in a plan view, while the portion of the source line 20 overlapping the gate line 19 and the auxiliary capacitor line 25 in a plan view is formed to have a larger line width than the portion not overlapping the gate line 19 and the auxiliary capacitor line 25 in a plan view.

As illustrated in FIG. 6, the TFT 17 includes the gate electrode 17a formed from the first metal film 34, a channel 17d formed from the semiconductor film 36 and disposed so as to overlap the gate electrode 17a in a plan view, a protection portion 17e formed from the protection film 37 and including two openings 17e1 and 17e2 that penetrate at positions overlapping the channel 17d in a plan view, the source electrode 17b formed from the second metal film 38 and connected to the channel 17d via one of the openings 17e1 and 17e2, specifically the opening 17e1, and the drain electrode 17c formed from the second metal film 38 and connected to the channel 17d via the other one of the openings 17e1 and 17e2, specifically the opening 17e2. The gate electrode 17a includes a portion of the gate line 19 overlapping at least the source electrode 17b, the drain electrode 17c, and the channel 17d in a plan view. The channel 17d extends along the X-axis direction and bridges between the source electrode 17b and the drain electrode 17c to allow a flow of electrons between the electrodes 17b and 17c. The semiconductor film 36 that forms the channel 17d is an oxide semiconductor thin film. The oxide semiconductor thin film has electron mobility higher than that of an amorphous silicon thin film, for example, 20 to 50 times higher. Therefore, the TFTs 17 can be easily downsized and the amount of transmitted light through each pixel electrode 18 can be increased to the maximum level. This configuration is preferable for enhancement of image resolution and reduction of power consumption. Each TFT 17 including the oxide semiconductor thin film is an inverted-staggered type having a configuration in which the gate electrode 17a is disposed at the bottom and the channel 17d is disposed thereon with the gate insulator 35 interposed therebetween. A stacking structure of the TFT 17 is similar to that of a commonly-used TFT including an amorphous silicon thin film.

Each pixel electrode 18 is formed from the second transparent electrode film 24 as illustrated in FIG. 6. The pixel electrode 18 has a vertically-long rectangular overall shape (approximately rectangular shape) in a plan view and disposed in an area defined by the gate lines 19 and the source lines 20. One end of the pixel electrode 18 overlaps the gate line 19 in a plan view and the portion excluding the overlapping portion does not overlap the gate line 19 in a plan view. The non-overlapping portion includes a plurality of longitudinal slits 18a (two in FIG. 5), with which a comb-shaped portion is formed. This slit 18a extends to the portion of the pixel electrode 18 that overlaps the gate line 19 in a plan view. The lower end of the pixel electrode 18 in FIG. 5 is positioned between the lowest end position of the gate line 19 and the lowest end position of the drain electrode 17c, specifically closer to the lower end position of the drain electrode 17c. The pixel electrode 18 is formed on the second interlayer insulator 41 and the second interlayer insulator 41 exists between the pixel electrode 18 and the common electrode 22, which will be described below. Under the pixel electrode 18, the first interlayer insulator 39, the organic insulator 40, and the second interlayer insulator 41 are disposed. Portions of the first interlayer insulator 39, the organic insulator 40, and the second interlayer insulator 41 overlapping the drain electrodes 17c and the pixel electrodes 18 in a plan view include contact holes 26 that run through the films from the top to the bottom. The pixel electrodes 18 are connected to the respective drain electrodes 17c via the respective contact holes 26. When current is supplied to the gate electrode 17a of each TFT 17, current flows between the source electrode 17b and the drain electrode 17c through the channel 17d and a predetermined potential is applied to the pixel electrode 18.

The common electrode 22 is formed from the first transparent electrode film 23. The common electrode 22 is a solid trace formed in the substantially entire display area AA of the array board 11b. The common electrode 22 is sandwiched between the organic insulator 40 and the second interlayer insulator 41. A common potential (a reference potential) is applied to the common electrode 22 through a common line, which is not illustrated. By controlling the potential to be applied to the pixel electrode 18 by the TFT 17 as described above, a predetermined potential difference is generated between the electrodes 18 and 22. When the potential difference is generated between the electrodes 18 and 22, a fringe field (an oblique field) including a component in a direction normal to a plate surface of the array board 11b is applied to the liquid crystal layer 11c in addition to a component in a direction along the plate surface of the array board 11b because of the slit 18a of the pixel electrode 18. Therefore, not only alignment of the liquid crystal molecules in the slit 18a in the liquid crystal layer 11c but also alignment of the liquid crystal molecules on the pixel electrode 18 is properly switchable. With this configuration, the aperture ratio of the liquid crystal panel 11 increases and a sufficient amount of transmitted light is obtained. Furthermore, high view-angle performance is achieved. The common electrode 22 is provided with an opening 22a in a portion overlapping with a portion of the TFT 17 in a plan view (specifically, in the range of an approximately rectangular shape surrounded by a two-dot chain line in FIG. 5). The alignment film 11e is a solid pattern formed in the substantially entire display area AA within the plate surface of the array board 11b so as to cover the pixel electrodes 18 and the common electrode 22.

Next, configurations of components in the display area AA of the CF board 11a will be described in detail. As illustrated in FIG. 3, the CF board 11a includes color filters 11h including red (R), green (G), and blue (B) color portions arranged in a matrix so as to overlap the pixel electrodes 18 on the array board 11b side in a plan view. A light blocking layer (a light blocking portion, a black matrix) 11i is formed in a grid for preventing colors from mixing. Each line of the grid is located between the adjacent color portions of the color filters 11h. The light blocking layer 11i is disposed in to overlap the gate lines 19 and the source lines 20 in a plan view in the display area AA. An OC layer (an overcoat layer) 11k is formed on the CF board 11a so as to cover the color filters 11h and the light blocking layer 11i. The OC layer 11k is made of acrylic resin (e.g., polymethylmethacrylate resin (PMMA)) which is an organic material. The OC layer 11k functions as a planarization film. Spacers (photo spacers) 111 are formed on the CF board 11a so as to overlap portions of the OC layer 11k. The spacers 111 have column-like shapes that protrude from the OC layer 11k toward the array board 11b through the liquid crystal layer 11c and contact the alignment film 11e on the array board 11b. With the spacers 111, the distance between the boards 11a and 11b (or the internal space IS), that is, the cell gap is maintained constant in the display area AA. A number of the spacers 111 are dispersed in the display area AA for each pixel (see FIG. 8). The spacers 111 are disposed at positions that overlap positions of the light blocking layer 11i that are between color portions of the color filters 11h in a plan view. According to the configuration, rays of light from the array board 11b toward the color portions are less likely to be blocked. The alignment film 11d is a solid pattern formed within the plate surface of the CF board 11a for about the entire display area AA so as to cover the OC layer 11k and the spacers 111. Each display pixel of the liquid crystal panel 11, which is a unit of display, includes a set of three color portions, that is, R (red), G (green) and B (blue) color portions and three pixel electrodes 18 opposite to the color portions. The display pixel includes a red pixel including the R color portion, a green pixel including the G color portion, and a blue pixel including the B color portion. The pixels are arranged on the plate surface of the liquid crystal panel 11 in repeated sequence along the row direction (the X-axis direction) and form groups of pixels. The groups of pixels are arranged in the column direction (the Y-axis direction).

Driving of the liquid crystal panel 11 will be described. In driving of the liquid crystal panel 11, operations of the TFTs 17 are controlled by a control circuit board 12 that supplies signals to the liquid crystal panel via the driver 21 to control operations of the TFTs 17. The control circuit board 12 supplies scanning signals to the gate lines 19 and data signals to the source lines 20 via the driver 21 for scanning the TFTs 17 included in the pixels, which are disposed along the row direction, along the column direction in sequence. According to the configuration, the pixel electrodes 18 in the pixels are charged in sequence along the column direction. The driving may include a scanning period (a refreshing period, a refreshing frame) and a non-scanning period (a non-refreshing period, a non-refreshing frame). In the scanning period, all gate lines 19 are scanned for refreshing the screen. In the non-scanning period, none of the gate lines 19 are scanned for halting the refreshing of the screen. According to the driving, operations of the control circuit board 12 and the driver 21 are halted and thus the power consumption of the liquid crystal display device 10 is reduced. This type of driving is referred to as “a non-scanning driving (a low frequency driving, an intermittent driving).” In this embodiment, specifically, as illustrated in FIG. 7, a refreshing rate is 1 Hz, the number of frames per the scanning period is 1, and the number of frames per an interval is 59. Therefore, the power consumption is significantly reduced. When the non-scanning driving is performed, a voltage charged to each pixel electrode 18 may decrease as the scan progresses during the non-scanning period. If a current leaks from the TFTs 17 or the pixel electrodes 18, the voltage at each pixel electrode 18 in the scanning period tends to decrease during the non-scanning period. As a result, the alignment in the liquid crystal layer 11c varies and the amount of transmitted light varies. This may cause a decrease in display quality. In this embodiment, the oxide semiconductors are used for the semiconductor films 36 of the TFTs 17 and thus the amount of off-leak current from the TFTs 17 is small. Each pixel electrode 18 has a high rate of maintaining a voltage and this is preferable for the non-scanning driving described above. The non-scanning driving is mainly used for displaying a still image on the liquid crystal panel.

In the liquid crystal panel 11, as illustrated in FIG. 3 and described earlier, the liquid crystal layer 11c is sealed with the sealing member 11j disposed therearound. According to the configuration, the liquid crystals in the liquid crystal layer 11c are less likely to leak to the outside or foreign substances are less likely to enter into the liquid crystal layer 11c. However, a forming area of the sealing member 11j may not be a constant for an entire length thereof. The forming area may include wide portions or narrow portions. In the production process of the liquid crystal panel 11, a material of the sealing member 11j is applied to the surface of the CF board 11a using a sealant dispenser. According to individual specificity of the sealant dispenser or temperature conditions, an amount of the material of the sealing member 11j may vary. If a larger amount of the material of the sealing member 11j is supplied, the sealing member 11j may have a wide portion, a width of which is larger than designed. If a smaller amount of the material of the sealing member 11j is supplied, the sealing member 11j may have a narrow portion, a width of which is smaller than designed. If the sealing member 11j has the wide portion, the material of the sealing member 11j may enter into the display area AA. As a result, the display quality may decrease. Furthermore, if the CF board 11a (or the liquid crystal panel 11) is prepared from a CF base board (or a panel base board) from which multiple CF boards 11a are prepared and the wide portion of the sealing member 11j has reached a boundary between the adjacent CF boards 11a, cutting of the CF base board for preparing the CF boards 11a may become difficult. If the sealing member 11j has the narrow portion, a moisture transmission rate is high in the narrow portion. Namely, moisture is more likely to enter the liquid crystal layer 11c via the narrow portion. If that occurs, a leak current from the TFTs 17 or the pixel electrodes 18 disposed near the sealing member 11j, that is, the outer edges of the display area AA may increase and the voltages charged to the pixel electrodes 18 tend to drop. For the non-scanning driving described earlier, if the voltage retaining rate of each pixel electrode 18 decreases, the voltage drop of the pixel electrode 18 becomes large in the non-scanning period. As a result, the display quality may significantly decrease.

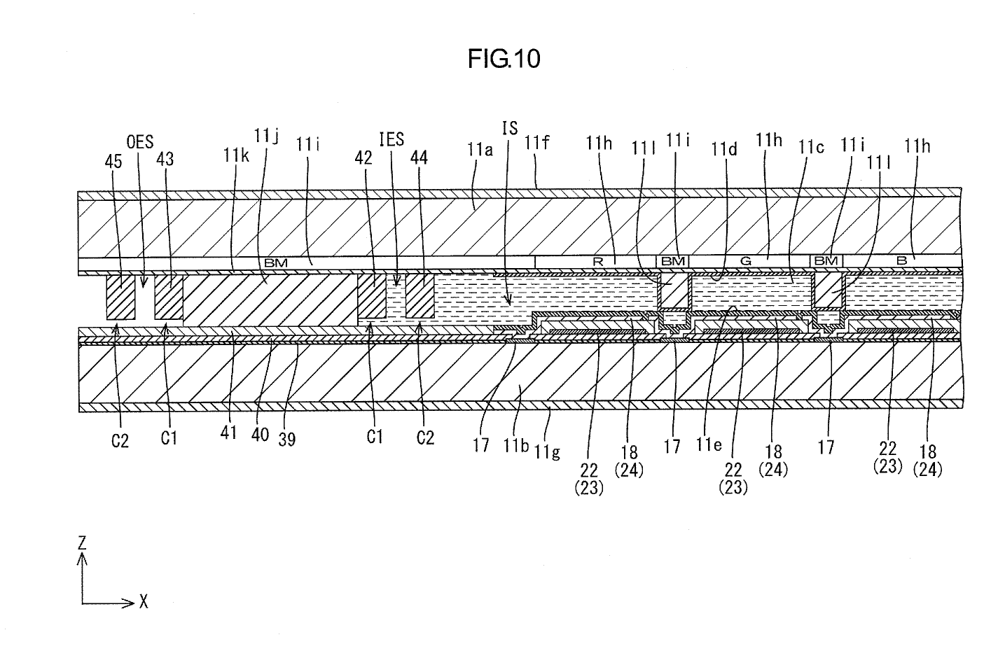

As illustrated in FIGS. 3 and 8, the liquid crystal panel 11 according to this embodiment includes a first inner limiting portion (an inner limiting portion, a liquid crystal-side limiting portion) 42 and a first outer limiting portion (an outer limiting portion, an opposite-side limiting portion) 43. The first inner limiting portion 42 is for limiting a forming area (or a width, a sealing width) of the sealing member 11j from the inner side, that is, a side closer to the internal space IS in which the liquid crystal layer 11c is formed. The first outer limiting portion 43 is for limiting the forming area of the sealing member 11j from the outer side, that is, a side away from the internal space IS. The first inner limiting portion 42 and the first outer limiting portion 43 are formed on the CF board 11a of the boards 11a and 11b, on which the sealing member 11j is formed, in the production process of the liquid crystal panel 11. The first inner limiting portion 42 and the first outer limiting portion 43 are disposed along the sealing member 11j for the entire periphery of the sealing member 11j. Each of the first inner limiting portion 42 and the first outer limiting portion 43 is formed in a vertically-long frame-like shape (a ring-like shape without an end) in a plan view. The first inner limiting portion 42 includes an outer peripheral surface that is in contact with the inner peripheral surface of the sealing member 11j for about an entire periphery of the sealing member 11j. The first outer limiting portion 43 includes an inner peripheral surface that is in (close) contact with the outer peripheral surface of the sealing member 11j for about the entire periphery of the sealing member 11j. Namely, a gap between the first inner limiting portion 42 and the first outer limiting portion 43 is about equal to the forming area of the sealing member 11j. The sealing member 11j is sandwiched between the first inner limiting portion 42 and the first outer limiting portion 43 for about the entire periphery thereof. In the production process of the liquid crystal panel 11, the first inner limiting portion 42 and the first outer limiting portion 43 may be formed on the CF board 11a in advance and the sealing material of the sealing member 11j may be applied to the gap between the first inner limiting portion 42 and the first outer limiting portion 43 by the sealant dispenser. Even if an excessive amount of the material is applied, the material is less likely to flow over the inner limit or the outer limit of the defined area. If the amount of the material is set larger than a normal amount before applying the material of the sealing member 11j, an amount sufficient for covering the forming area of the sealing member 11j even if the actual supplied amount is smaller than the set amount. Therefore, the sealing member 11j is less likely to have the narrow portion, and the forming area of the sealing member 11j is less likely to have a wide portion or a narrow portion. Furthermore, as illustrated in FIG. 10, the first inner limiting portion 42 and the first outer limiting portion 43 are made of the same material as that of spacers 111 that are included in the DF board 11a. During formation of the spacers 111 in the production process of the CF board 11a, the first inner limiting portion 42 and the first outer limiting portion 43 are formed simultaneously with the spacers 111. Namely, an extra step or an extra material for forming the first inner limiting portion 42 and the first outer limiting portion 43 is not required. This is advantageous for reducing the cost. The forming area of the sealing member 11j according to this embodiment has a dimension of about 1 mm. The width of the first inner limiting portion 42 and the width of the first outer limiting portion 43 are about equal to each other and about 30 μm. FIG. 10 schematically illustrates the components of the boards 11a and 11b similar to FIG. 4. Dimensions (thicknesses, heights) of the components illustrated in FIG. 10 may not be equal to the actual dimensions of the components.

As illustrated in FIGS. 3 and 8, the liquid crystal panel 11 according to this embodiment includes a second inner limiting portion (a second inner limiting portion, a second liquid crystal-side limiting portion) 44 and a second outer limiting portion (a second outer limiting portion, a second opposite limiting portion) 45. The second inner limiting portion 44 is disposed inner than the first inner limiting portion 42, that is, closer to the internal space IS in a distance from the internal space IS. The second outer limiting portion 45 is disposed outer than the first outer limiting portion 43 in a distance from the first outer limiting portion 43. The second inner limiting portion 44 and the second outer limiting portion 45 are formed on the CF board 11a of the boards 11a and 11b in the production process of the liquid crystal panel 11. The sealing member 11j, the first inner limiting portion 42, and the first outer limiting portion 43 are formed. The width of the second inner limiting portion 44 and the width of the second outer limiting portion 45 are about equal to the width of the first inner limiting portion 42 or the first outer limiting portion 43, that is, about 30 μm. The second inner limiting portion 44 and the second outer limiting portion 45 are disposed along the first inner limiting portion 42 and the first inner limiting portion 43 (or the sealing member 11j), respectively, for about the entire periphery of the first inner limiting portion 42 and the first outer limiting portion 43. Each of the second inner limiting portion 44 and the second outer limiting portion 45 has a vertically-long frame-like shape (a ring-like shape (a ring-like shape without an end) in a plan view. Specifically, the second inner limiting portion 44 has a frame-like shape slightly smaller than the first inner limiting portion 42. The outer peripheral surface of the second inner limiting portion 44 is opposite the inner peripheral surface of the first inner limiting portion 42 for the entire periphery thereof with a specified distance from the inner surface of the first inner limiting portion 42. As illustrated in FIGS. 9 and 10, space between the second inner limiting portion 44 and the first inner limiting portion 42 is an inner escape space IES for releasing an excessive material when an excessive amount of the material of the sealing member 11j is supplied. A width of the inner escape portion IES (a distance between the first inner limiting portion 42 and the second inner limiting portion 44) is smaller than the width of the first inner limiting portion 42 or the second inner limiting portion 44 and larger than a diameter of the spacer particles SP, for example, about 20 μm. As illustrated in FIGS. 3 and 8, the second outer limiting portion 45 has a frame-like shape slightly larger than the first outer limiting portion 43. An inner peripheral surface of the second outer limiting portion 45 is opposite the outer peripheral surface of the first outer limiting portion 43 for the entire periphery thereof with a predetermined distance from the outer surface of the first outer limiting portion 43. As illustrated in FIGS. 9 and 10, space between the second outer limiting portion 45 and the first outer limiting portion 43 is outer escape space OES. A width of the outer escape space OES (a distance between the first outer limiting portion 43 and the second outer limiting portion 45) is smaller than the width of the first outer limiting portion 43 or the second outer limiting portion 45 and larger than the diameter of the spacers SP, for example, about 20 μm. Namely, the first inner limiting portion 42 and the first outer limiting portion 43 that are in contact with the sealing member 11j are between the inner escapes space IES on the inner side and the outer escape space OES on the outer side. If an excessive amount of the material of the sealing member 11j is supplied, the excessive material is released to the inner escape space IES and the outer escape space OES. Furthermore, the excessive material is less likely to leak and spread to the inner side or the outer side of the second inner limiting portion 44 and the second outer limiting portion 45. As illustrated in FIG. 10, similar to the first inner limiting portion 42 and the first outer limiting portion 43, the second inner limiting portion 44 and the second outer limiting portion 45 are made of the same material as that of the spacers 111 included in the CF board 11a. In the production process of the CF board 11a, the second inner limiting portion 44 and the second outer limiting portion 45 are formed simultaneously with the spacers 111. Therefore, an extra step or an extra material is not required for forming the second inner limiting portion 44 and the second outer limiting portion 45. This is advantageous for reducing the cost.

As illustrated in FIGS. 10 and 11, the first inner limiting portion 42 and the first outer limiting portion 43 described earlier are formed on the CF board 11a such that first gaps C1 are provided between the array board 11b opposite the CF board 11a and the first inner limiting portion 42 and the first outer limiting portion 43, respectively. Similarly, the second inner limiting portion 44 and the second outer limiting portion 45 are disposed on the CF board 11a such that second gaps C2 are formed between the array board 11b opposite the CF board 11a and the second inner limiting portion 44 and the second outer limiting portion 45, respectively. As illustrated in FIG. 11, each of the gaps C1 and C2 between the limiting portions 42 to 45 and the array board 11b is far smaller than the diameter of the spacer particles SP included in the material of the sealing member SP. Each of the gaps C1 and C2 passes the ultraviolet curing resin UR but does not pass the spacer particles SP. If the excessive amount of the material of the sealing member 11j is supplied, the ultraviolet curing resin UR in the excessive material is released to the inner escape space IES between the first inner limiting portion 42 and the second inner limiting portion 44 or to the outer escape space OES between the first outer limiting portion 43 and the second outer limiting portion 45 via the first gaps C1. If an further excessive amount of the material of the sealing member 11j is supplied and the amount exceeds a capacity of the inner escape space IES or the outer escape space OES, the excessive material is released to the inner side than the second inner limiting portion 44 or the outer side than the second outer limiting portion 45 via the second gaps C2. The capacity of the inner escape space IES is proportional to the gap between the first inner limiting portion 42 and the second inner limiting portion 44. The capacity of the outer escapes space OES is proportional to the gap between the first outer limiting portion 43 and the second outer limiting portion 45.

This embodiment has the configuration described above. Next, a method of producing the liquid crystal panel 11 will be described. The liquid crystal panel 11 according to this embodiment is produced through a CF board preparing process, an array board preparing process, a sealing member forming process, a one drop filling process (a liquid crystal arrangement process), a bonding process, and a cutting process. The CF board preparing process is for preparing the CF base board including multiple CF boards 11a. The array board preparing process is for preparing the array base board including multiple array boards 11b. The sealing member forming process is for forming the sealing member 11j on each CF board 11a of the CF base board. The one drop filling process is for dropping (or arranging) the liquid crystal material for the liquid crystal layer 11c on each CF board 11a of the CF base board. The bonding process is for bonding the CF base board and the array base board together for preparing a panel base board 11M. The cutting process is for cutting the panel base board 11M into multiple liquid crystal panels 11.

In the CF board preparing process, the components are formed in layers on the glass substrate GS of the CF board 11a in sequence by a known photolithography. A large so-called mother glass from which multiple CF boards 11a are prepared is used. The mother glass is divided into sections that correspond to the CF boards 11a and components of each CF board 11a are formed in layers in each section. As a result, the CF base board is prepared. In the array board preparing process, the components are formed on the glass substrate GS of the array board 11b in sequence by a known photolithography. A large so-called mother glass from which multiple array boards 11b are prepared is used. The mother glass is divided into sections that correspond to the array boards 11b and components of each array board 11b are formed in layers in each section. As a result, the array base board is prepared.

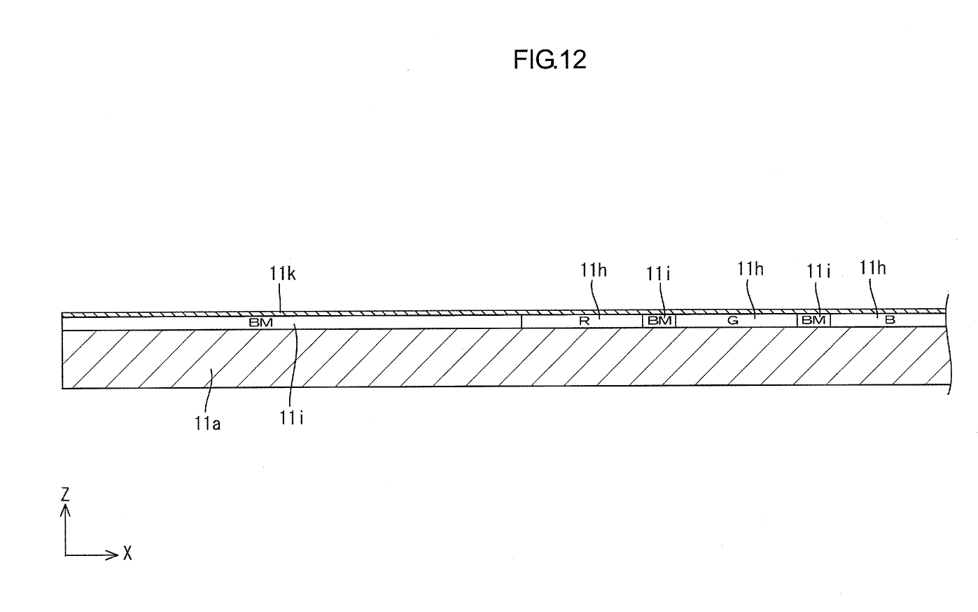

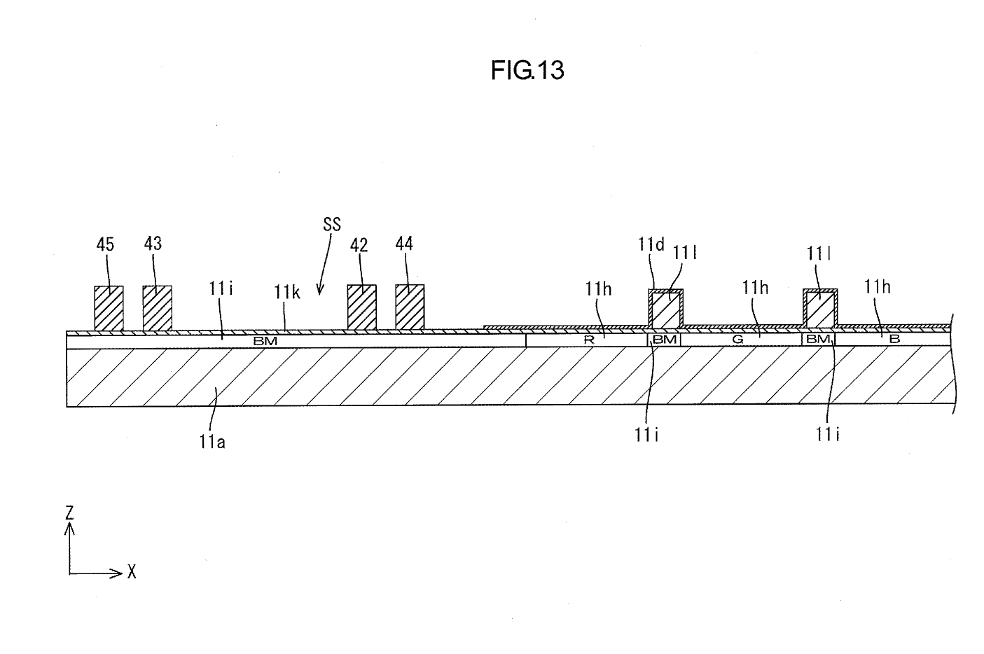

The CF board preparing process will be described in detail. The CF board preparing process includes at least a light blocking layer forming step (a light blocking portion forming step), a color filter forming step, an OC layer forming step (a planarization film forming step), a spacer and limiting portion forming step (a limiting portion forming step), and an alignment film forming step. The light blocking layer forming step is for forming the light blocking layer 11i on the mother glass (or the glass substrate GS). The color filter forming step is for forming the color portions of the color filters 11h in sequence on the mother glass on which the light blocking layer 11i is formed. The OC layer forming step is for forming the OC layer 11k layered on the light blocking layer 11i and the color filters 11h. The spacer and limiting portion forming step is for forming the spacers 111 and the limiting portions 42 to 45 layered on the OC layer 11k. The alignment film forming step is for forming the alignment film 11d layered on the OC layer 11k, the spacers 111, and the limiting portions 42 to 45. In the spacer and limiting portion forming step, as illustrated in FIG. 12, the photosensitive resin to form the spacers 111 and the limiting portions 42 to 45 is applied to the OC layer 11k that is the top layer when the light blocking layer forming step, the color filter forming step, and the OC layer forming step are complete. The photosensitive resin is applied in a solid pattern. The photosensitive resin is exposed using a mask having a predetermined pattern and developed. As a result, the spacers 111 and the limiting portions 42 to 45 are patterned as illustrated in FIG. 13. The spacers 111 and the limiting portions 42 to 45 are made of the same material and formed simultaneously in the spacer and limiting portion forming step. Sealing forming space SS for forming the sealing member 11j is provided between the first inner limiting portion 42 and the first outer limiting portion 43. Furthermore, the inner escapes space IES provided between the first inner limiting portion 42 and the second inner limiting portion 44 and the outer escape portion OES is provided between the first outer limiting portion 43 and the second outer limiting portion 45.

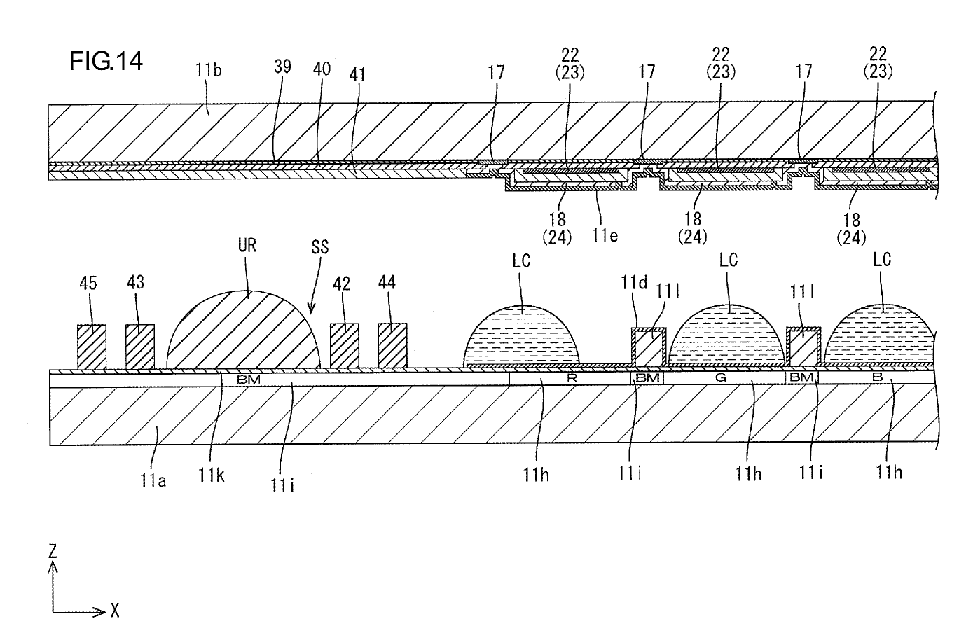

On the CF base board (or the CF boards 11a) prepared through the CF board preparing process described above, the sealing member 11j is formed through the sealing member forming process. In the sealing member forming process, using a nozzle of the sealant dispenser, which is not illustrated, the material of the sealing member 11j is applied in the sealing forming space SS that is provided in advance between the first inner limiting portion 42 and the first outer limiting portion 43. During the application of the material, either one of or both of the CF base board and the nozzle of the sealant dispenser are moved. As a result, the sealing member 11j having a frame-like shape in a plan view is formed for the entire periphery of the sealing forming space SS. The amount of the material of the sealing member 11j to be supplied from the sealant dispenser to the CF base board is set larger than the normal amount. For example, if a set area in which the sealing member 11j will be formed, that is, the width of the sealing forming space SS between the first inner limiting portion 42 and the first outer limiting portion 43 is 1 mm, the amount of the material of the sealing member 11j to be supplied by the sealant dispenser is set such that the forming area of the sealing member 11j has a width of 1.1 mm. Namely, the amount of the material of the sealing member 11j supplied by the sealant dispenser is set such that the forming area of the sealing member 11j with the supplied material has a width larger than the distance between the first inner limiting portion 42 and the first outer limiting portion 43. Even if the actual supplied amount of the material of the sealing member 11j is lower than an assumed lower limit due to the individual specificity of the sealant dispenser or the temperature conditions, the amount of the material sufficient for forming the sealing member 11j having a target forming area is supplied. Therefore, the sealing member 11j is less likely to have the narrow portion. In FIG. 14, only the ultraviolet curing resin UR amount the material of the sealing member 11j is illustrated and the spacer particles SP are not illustrated.

The one drop filling process is performed after the sealing forming process. In the one drop filling process, as illustrated in FIG. 14, drops of liquid crystal materials LC for the liquid crystal layer 11c are placed at predefined intervals in an area inner than the second inner limiting portion 44 on the CF base board to which the material of the sealing member 11j is applied (an area correspond with the internal space IS). In the bonding process performed next, the array base board (or the array boards 11b) prepared through the array board preparing process is placed opposite the CF base board on which the liquid crystal material LC is dropped and positioned to each other. Then, the array base board is bonded to the CF base board. The drops of the liquid crystal material LC for the liquid crystal layer 11c are pressed and spread between the CF base board and the array base board. As a result, the liquid crystal material LC is evenly placed for the entire area in the internal space IS. The material of the sealing member 11j is press and spread between the CF base board and the array base board and thus evenly placed for the entire area in the sealing forming space SS between the first inner limiting portion 42 and the first outer limiting portion 43. When the ultraviolet rays are applied to the sealing member 11j from the array board 11b side, the ultraviolet curing resin UR is hardened and the liquid crystal layer 11c in the internal space IS is sealed.

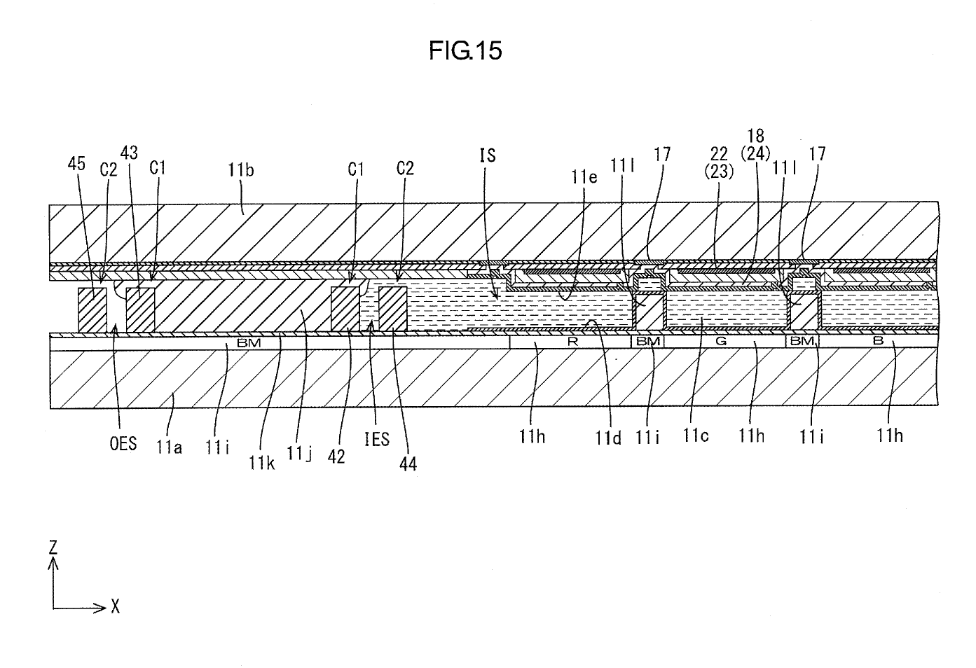

If the excessive amount of the material of the sealing member 11j is supplied, the ultraviolet curing resin UR in the material is released to the inner escapes space IES or the outer escapes space OES via the first gaps C1 as illustrated in FIG. 15. Each first gap C1 is located between the first inner limiting portion 42 and the array base board or the first outer limiting portion 43 and the array base board. The inner escape space IES is located between the first inner limiting portion 42 and the second inner limiting portion 44. The outer escapes space OES is located between the first outer limiting portion 43 and the second outer limiting portion 45. The ultraviolet curing resin UR is a large portion of the material of the sealing member 11j (about 99 wt %). Therefore, even if the space particles SP are not released through the first gaps C1, problems are less likely to occur. If the excessive amount of the material of the sealing member 11j exceeds the capacities of the inner escapes space IES and the outer escape space OES, the material may be released to space inner than the second inner limiting portion 44 or space outer than the second outer limiting portion 45. To increase the capacities of the inner escapes space IES and the outer escape space OES for receiving the material of the sealing member 11j, the distance between the first inner limiting portion 42 and the second inner limiting portion 44 and the distance between the first outer limiting portion 43 and the second outer limiting portion 45 need to be increased. If they are increased, larger space is required for the limiting portions 42 to 45. This causes disadvantage, that is, an increase in width of the frame of the liquid crystal panel 11. This embodiment includes the second gaps C2 between the second inner limiting portion 44 and the array base board and between the second outer limiting portion 45 and the array base board. Therefore, the excessive material of the sealing member 11j is normally released to the inner escape space IES and the outer escape space OES via the first gaps C1 and to the inner space or the outer space via the second gap C2 in case of overflow without increasing the distance between the first inner limiting portion 42 and the second inner limiting portion 44 and the distance between the first outer limiting portion 43 and the second outer limiting portion 45. This is advantageous for reducing the frame size of the liquid crystal panel 11. In the bonding process, the distance between the CF base board and the array base board, that is, the cell gap is set about constant with the spacers 111.

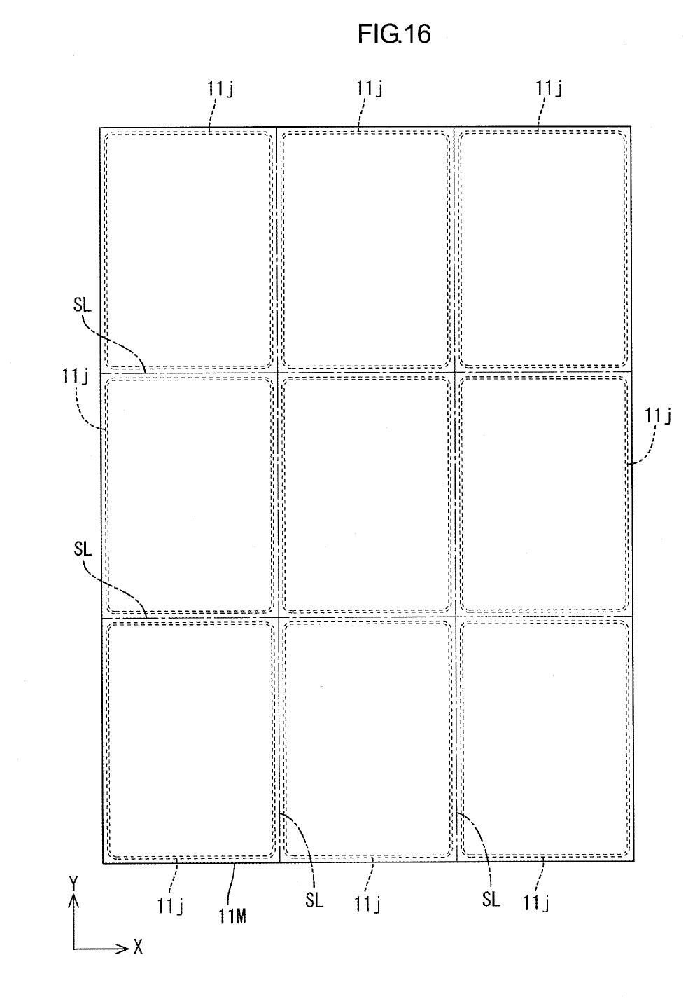

As illustrated in FIG. 16, the panel base board 11M including the CF base board and the array base board bonded together is prepared through the bonding process described above. From the panel base board 11M, three by three along the X-axis direction and the Y-axis direction, respectively, that is, a total of nine liquid crystal panels 11 are prepared. In FIG. 16, scribed lines SL among the liquid crystal panels 11 are illustrated with chain lines. Next, in the cutting process, the panel base board 11M is cut along the scribed lines SL using a cutting machine that is not illustrated to prepare the liquid crystal panels 11. If the sealing member 11j has the wide portion and the wide portion is on the scribed line SL that is a cutting portion, the cutting by the cutting machine may be difficult or the cutting may not be performed. In this embodiment, the wide portion is less likely to be formed because the forming area of the sealing member 11j is limited by the first inner limiting portion 42 and the first outer limiting portion 43. Therefore, the cutting in the cutting process is properly performed.

As described above, the liquid crystal panel (a display panel) 11 of this embodiment includes the first board (the CF board 11a or the array board 11b), the second board (the array board 11b or the CF board 11a), the sealing member 11j, the first inner limiting portion 42, and the first outer limiting portion 43. The second board is disposed opposite the first board such that the internal space IS is provided between the first board and the second board. The sealing member 11j is disposed between the first board (the CF board 11a or the array board 11b) and the second board (the array board 11b or the CF board 11a) so as to surround the internal space IS and seal the internal space IS. The first inner limiting portion (an inner limiting portion) 42 is included in at least one of the first board (the CF board 11a or the array board 11b) and the second board (the array board 11b or the CF board 11a). The first inner limiting portion 42 is located closer to the internal space IS than the sealing member 11j to limit the forming area of the sealing member 11j from the internal space IS side. The first outer limiting portion 43 is located on the outer side farther from the internal space IS than the sealing member 11j to limit the forming area of the sealing member 11j from the outer side.

The internal space IS is provided between the first board (the CF board 11a or the array board 11b) and the second board (the array board 11b or the CF board 11a) that are opposite to each other. The sealing member 11j is disposed so as to surround the internal space IS and the internal space IS is sealed with the sealing member 11j. The amount of the material supplied to at least one of the first board (the CF board 11a or the array board 11b) and the second board (the array board 11b or the CF board 11a) during the formation of the sealing member 11j varies according to the individual specificity of the machine that supplies the material or the temperature conditions. Therefore, the amount of the material of the sealing member 11j to be supplied may be set larger than the normal amount so that the material of the sealing member 11j actually supplied is less likely to be short. Because the forming area of the sealing member 11j is less likely to be smaller than designed, the moisture is less likely to enter from the outside to the internal space IS. Therefore, the display quality is less likely to decrease.

When the amount of the material of the sealing member 11j to be supplied is set larger as described above, the excessive amount of the material of the sealing member 11j may be supplied. However, the forming area of the sealing member 11j is limited by the first inner limiting portion 42 located closer to the internal space IS and the first outer limiting portion 43 located on the outer side farther from the internal space IS. Therefore, the forming area of the sealing member 11j is less likely to become larger than designed. Because the forming area of the sealing member 11j is less likely to expand toward the internal space IS, the display quality is less likely to decrease and the forming area of the sealing member 11j is less likely to expand toward the outside farther from the internal space IS. Therefore, the appearance of the liquid crystal panel 11 is less likely to degrade. Furthermore, in the production process of the liquid crystal panel 11, the cutting of the base board is properly performed for preparing multiple liquid crystal panels 11 from the base board.

The first inner limiting portion 42 and the first outer limiting portion 43 are in contact with the sealing member 11j. According to the configuration, the forming area of the sealing member 11j is further properly limited.

The second inner limiting portion (a second inner limitation portion) 44 is included in at least one of the first board (the CF board 11a or the array board 11b) and the second board (the array board 11b or the CF board 11a). The second inner limiting portion 44 is located closer to the internal space IS than the first inner limiting portion 42 with the gap therebetween. The second outer limiting portion (the second outer limiting portion) 45 is included in at least one of the first board (the CF board 11a or the array board 11b) and the second board (the array board 11b or the CF board 11a). The second outer limiting portion 45 is located on the outer side farther from the internal space IS than the first outer limiting portion 43 with the gap therebetween. Even if the excessive amount of the material is supplied during the formation of the sealing member 11j, the excessive material of the sealing member 11j is released to at least one of the space between the first inner limiting portion 42 and the second inner limiting portion 44 and the space between the first outer limiting portion 43 and the second outer limiting portion 45. If the second inner limiting portion 44 is included, the excessive material of the sealing member 11j is released to the space between the first inner limiting portion 42 and the second inner limiting portion 44. Furthermore, with the second inner limiting portion 44, the material is less likely to leak to the internal space IS and thus a decrease in display quality is further properly restricted. If the second outer limiting portion 45 is included, the excessive material of the sealing member 11j is released to the space between the first outer limiting portion 43 and the second outer limiting portion 45. Furthermore, with the second outer limiting portion 45, the material is less likely to leak to the outside farther from the internal space IS and thus a decrease in display quality is further properly restricted. Still furthermore, the cutting for preparing the liquid crystal panels 11 from the baser board is more properly performed in the production process of the liquid crystal panel 11.

At least one of the second inner limiting portion 44 and the second outer limiting portion 45 is along the sealing member 11j for the entire periphery of the sealing member 11j. Even if the excessive amount of the material is supplied during the formation of the sealing member 11j, at least one of the second inner limiting portion 44 and the second outer limiting portion 45 along the sealing member 11j for the entire periphery more properly restricts the leak of the excessive material of the sealing member 11j to the internal space IS or the outer side away from the internal space IS.

At least one of the first inner limiting portion 42 and the first inner limiting portion 43 is included in the CF board 11a that is one of the first board (the CF board 11a or the array board 11b) and the second board (the array board 11b or the CF board 11a) such that the first gap (a gap) C1 is provided between at least one of the first inner limiting portion 42 and the first inner limiting portion 43 and the array board 11b that is the other board. Even if the excessive amount of the material is supplied during the formation of the sealing member 11j, the excessive material of the sealing member 11j is released to the space between the first inner limiting portion 42 and the second inner limiting portion 44 or the space between the first outer limiting portion 43 and the second outer limiting portion 45 via the first gap C1. This is because the at least one of the first inner limiting portion 42 and the first outer limiting portion 43 is included in one of the first board (the CF board 11a or the array board 11b) and the second board (the array board 11b or the CF board 11a) such that the first gaps C1 is provided between at least one of the first inner limiting portion 42 and the first outer limiting portion 43 and the array board 11b that is the other board.

At least one of the second inner limiting portion 44 and the second outer limiting portion 45 is included in the CF board 11a that is one of the first board (the CF board 11a or the array board 11b) and the second board (the array board 11b or the CF board 11a) such that the second gap (a gap) C2 is provided between at least one of the second inner limiting portion 44 and the second outer limiting portion 45 and the array board 11b that is the other board. The larger the distance between the first inner limiting portion 42 and the second inner limiting portion 44 or the distance between the first outer limiting portion 43 and the second outer limiting portion 45, the larger the amount of the excessive material of the sealing member 11j to be released. However, the space in which the limiting portions are formed becomes larger and the frame of the liquid crystal panel 11 becomes wider. As described above, at least one of the second inner limiting portion 44 and the second outer limiting portion 45 is included in the CF board 11a that is one of the first board (the CF board 11a or the array board 11b) and the second board (the array board 11b or the CF board 11a) such that the second gap C2 is provided between at least one of the second inner limiting portion 44 and the second outer limiting portion 45 and the array board 11b that is the other board. Therefore, even if the distance between the first inner limiting portion 42 and the second inner limiting portion 44 or the distance between the first outer limiting portion 43 and the second outer limiting portion 45 is not large, the excessive material of the sealing member 11j is released to the space between the first inner limiting portion 42 and the second inner limiting portion 44 or the space between the first outer limiting portion 43 and the second outer limiting portion 45 up to the upper limit. If the amount of the supplied material of the sealing member 11j exceeds the upper limit, the excessive material is released to the internal space IS or the outer side via the second gap C1 between at least one of the second inner limiting portion 44 and the second outer limiting portion 45 and the array board 11b that is the other board. The distance between the first inner limiting portion 42 and the second inner limiting portion 44 or the distance between the first outer limiting portion 43 and the second outer limiting portion 45 can be defined as small as possible. This is advantageous for reducing the frame size of the liquid crystal panel 11.

The CF board 11a that is one of the first board (the CF board 11a or the array board 11b) and the second board (the array board 11b or the CF board 11a) includes at least the color filters including the color portions, the light blocking portions, and the spacers. Each light blocking portion is arranged between the adjacent color portions. The spacers define the distance to the array board 11b that is the other one of the first board (the CF board 11a or the array board 11b) and the second board (the array board 11b and the CF board 11a). The first inner limiting portion 42 and the first outer limiting portion 43 are included in the CF board 11a that is one of the boards. The first inner limiting portion 42 and the first outer limiting portion 43 are made of the same material as that of at least one of the color filters, the light blocking portions, and the spacers. The first inner limiting portion 42 and the first outer limiting portion 43 are made of the same material as that of at least one of the color filters, the light blocking portions, and the spacers that are originally included in the CF board 11a that is one of the boards. Therefore, the cost for forming the first inner limiting portion 42 and the first outer limiting portion 43 in the CF board 11a that is one of the boards can be reduced.

One of the first board (the CF board 11a or the array board 11b) and the second board (the array board 11b or the CF board 11a) includes at least the TFTs (switching components) 17 and the pixel electrodes 18. The oxide semiconductors are used for the semiconductor films 36 of the TFTs 17. The pixel electrodes 18 are connected to the TFTs 17. Because the oxide semiconductors are used for the semiconductor films 36 of the TFTs 17, in comparison to a configuration in which the amorphous silicon is used for the semiconductor films 36, the off-leak currents of the TFTs 17 are small. This is advantageous for non-scanning driving (low frequency driving) during the still image display. If the moisture enters from the outside to the internal space IS through the sealing member 11j, the leak currents from the pixel electrodes 18 tend to increase due to the moisture. As a result, the voltage of each pixel electrode 18 charged through the corresponding TFT 17 tends to drop during the non-scanning driving. As described earlier, with the first inner limiting portion 42 and the first outer limiting portion 43, the forming area of the sealing member 11j is less likely to become smaller than designed. Therefore, the moisture is less likely to enter from the outside to the internal space IS through the sealing member 11j and thus the voltage drop of the pixel electrode 18 due to the moisture is less likely to occur. As a result, the display quality is maintained at a high level.

The oxide semiconductor of the semiconductor film 36 contains mainly indium (In), gallium (Ga), zinc (Zn), and oxygen (O). According to the configuration, the off-leak current from the TFT 17 is smaller. The high voltage retaining rate of the pixel electrode 18 is achieved. This is further advantageous for the non-scanning driving (low frequency driving) during the still image display.

The liquid crystal layer (liquid crystals) 11c is in the internal space IS between the first board (the CF board 11a or the array board 11b) and the second board (the array board 11b or the CF board 11a). The liquid crystal layer 11c in the internal space IS between the first board (the CF board 11a or the array board 11b) and the second board (the array board 11b or the CF board 11a) opposite to each other is sealed with the sealing member 11j that surrounds the internal space IS.

The method of producing the liquid crystal panel 11 includes the limiting portion forming process, the sealing member forming process, and the bonding process. The limiting portion forming process is for forming the first inner limiting portion 42 at the position closer to the internal space IS on the CF board 11a and the first outer limiting portion 43 farther from the internal space IS on the CF board 11a that is one of the first board (the CF board 11a or the array board 11b) and the second board (the array board 11b or the CF board 11a). The sealing member forming process is for forming the sealing member 11j between the first inner limiting portion 42 and the first outer limiting portion 43 on the CF board 11a that is one of the boards. The bonding process is for placing the array board 11b that is the other one of the first board (the CF board 11a or the array board 11b) and the second board (the array board 11b or the CF board 11a) opposite the CF board 11a that is one of the boards such that the internal space IS is therebetween and bonding the array board 11b to the CF board 11a.

In the limiting portion forming process, the first inner limiting portion 42 and the first outer limiting portion 43 are formed on the CF board 11a that is one of the first board (the CF board 11a or the array board 11b) and the second board (the array board 11b or the CF board 11a). In the sealing member forming process, the sealing member 11j is formed in the space between the first inner limiting portion 42 and the first outer limiting portion 43 that is formed in advance on the CF board 11a that is one of the boards. Therefore, the forming area of the sealing member 11j is properly limited by the first inner limiting portion 42 and the first outer limiting portion 43. In the bonding process, the array board 11b that is the other one of the first board (the CF board 11a or the array board 11b) and the second board (the array board 11b or the CF board 11a) is bonded to the CF board 11a that is one of the boards such that the internal space IS is therebetween. As a result, the internal space IS is sealed with the sealing member 11j.

In the sealing member forming process, the amount of the material of the sealing member 11j supplied to the CF board 11a that is one of the boards may vary according to the individual specificity of the machine that supplies the material or the temperature conditions. If the amount of the material of the sealing member 11j to be supplied is set larger than the normal amount, the material of the sealing member 11j which is actually supplied is less likely to be short. Therefore, the forming area of the sealing member 11j is less likely to have a portion narrower than designed. The moisture is less likely to enter from the outside to the internal space IS through the sealing member 11j. Therefore, the display quality is less likely to decrease.

If the amount of the material of the sealing member 11j to be supplied is defined as described above, an excessive amount of the material of the sealing member 11j may be supplied. However, the forming area of the sealing member 11j is limited by the first inner limiting portion 42 located closer to the internal space IS and the first outer limiting portion 43 located on the outer side farther from the internal space IS. Therefore, the forming area of the sealing member 11j is less likely to become larger than designed. Namely, the forming area of the sealing member 11j is less likely to expand toward the internal space IS. The display quality is less likely to decrease and the forming area of the sealing member 11j is less likely to expand toward the outside farther from the internal space IS. The appearance of the liquid crystal panel 11 is less likely to degrade. Furthermore, in the process for producing the liquid crystal panel 11, the cutting of the base board for preparing the liquid crystal panels 11 from the base board is properly performed.

In the sealing member forming process, the amount of the material of the sealing member 11j to be supplied to the CF board 11a that is one of the boards is set such that the area in which the sealing member 11j if formed is larger than the distance between the first inner limiting portion 42 and the first outer limiting portion 43. In the sealing member forming process, the material of the sealing member 11j is supplied to the CF board 11a that is one of the boards with the amount to form the sealing member 11j such that the area thereof is larger than the distance between the first inner limiting portion 42 and the first outer limiting portion 43. Even if the amount actually supplied is smaller than the set amount due to the individual specificity of the machine that supplies the material or the temperature conditions, the material of the sealing member 11j will not be short. The forming area of the sealing member 11j is less likely to become smaller than designed. Therefore, the moisture is less likely to enter from the outside to the internal space IS through the sealing member 11j and thus the display quality is less likely to decrease.

### Second Embodiment

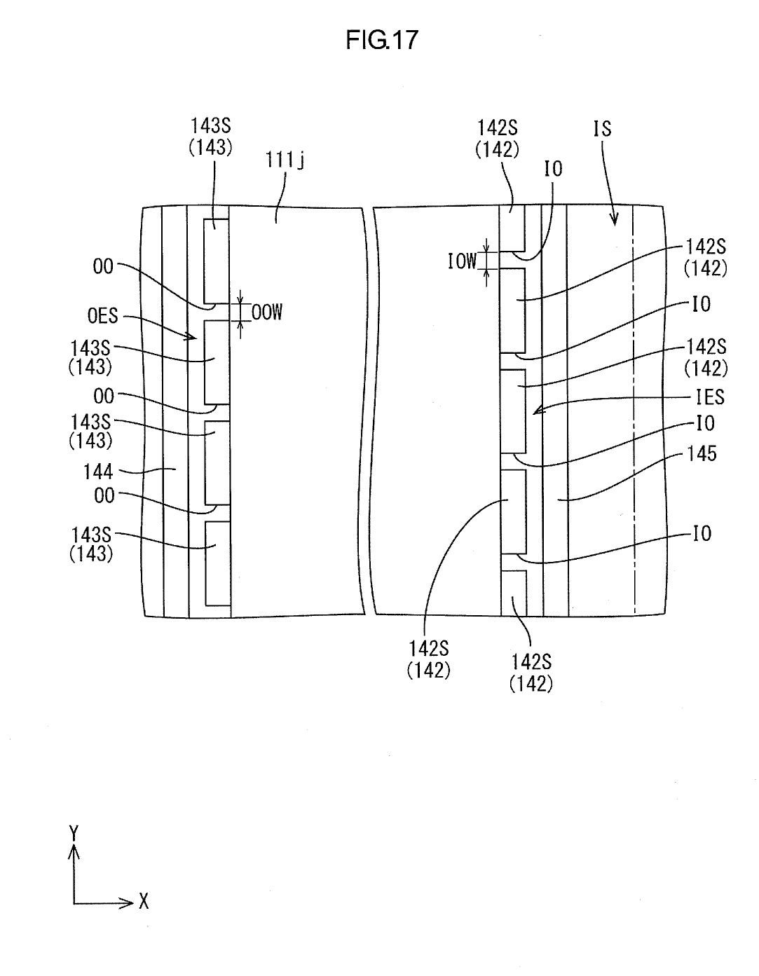

A second embodiment according to the present invention will be described with reference to FIG. 17. The second embodiment includes a first inner limiting portions 142 and a first outer limiting portions 143 having different configurations. Structures, functions, and effects similar to those of the first embodiment will not be described.

As illustrated in FIG. 17, the first inner limiting portions 142 and the first outer limiting portion 143 according to this embodiment are formed at intervals along a peripheral direction of a sealing member 111j. Specifically, the first inner limiting portions 142 include first inner limiting sections 142S arranged along the sealing member 111j. Inner openings IO that open in and out are provided between the adjacent first inner limiting sections 142S. The first inner limiting sections 142S are arranged at about equal intervals along the sealing member 111j. Opening widths of the inner openings IO between the first inner limiting sections 142S are about equal. The first outer limiting portions 143 include first outer limiting sections 143S arranged along the sealing member 111j. Outer openings OO that open in and out are provide between the adjacent first outer limiting sections 143S. The first outer limiting sections 143S are arrange at about equal intervals along the sealing member 111j. Opening widths of the outer openings OO between the first outer limiting sections 143S are about equal. The first inner limiting sections 142S of the first inner limiting portions 142 and the first outer limiting sections 143S of the first outer limiting portions 143 are arranged such that the inner openings IO and the outer openings OO do not overlap with respect to a direction (the X-axis direction in FIG. 17) perpendicular to a direction in which the sealing member 111j extends (the Y-axis direction in FIG. 17). During formation of the sealing member 111j, a material of the sealing member 111j is passed through the inner openings IO of the first inner limiting portions 142 and the outer openings OO of the first outer limiting portions 143. The opening widths IOW and OOW of the inner openings IO of the first inner limiting portions 142 and the outer openings OO of the first outer limiting portions 143 are larger than the diameter of the spacer particles in the material of the sealing member 111j (see FIG. 11). During the formation of the sealing member 111j, the spacer particles in the material of the sealing member 111j having the excessive amount are smoothly released to inner escape space IES between the first inner limiting portion 142 and the second inner limiting portion 144 or outer escape space OES between the first outer limiting portion 143 and the second outer limiting portion 145 through the inner opening IO and the outer opening OO of the first outer limiting portion 143. According to the configuration, the spacer particles are less likely to move over the first inner limiting portions 142 or the first outer limiting portions 143. Therefore, a cell gap between the boards is less likely to become uneven.

As described above, in this embodiment, at least one of the first inner limiting portions 142 and the first outer limiting portions 143 are arranged at intervals along the peripheral direction of the sealing member 111j. Even if the excessive amount of the material is supplied during the formation of the sealing member 111j, the excessive material is smoothly released to the space between the first inner limiting portion 142 and the second inner limiting portion 144 or the space between the first outer limiting portion 143 and the second outer limiting portion 145 through the openings of at least one of the first inner limiting portions 142 and the first outer limiting portions 144 that are arranged at intervals along the peripheral direction of the sealing member 111j.

The sealing member 111j includes at least the ultraviolet curing resin (a hardening resin) and the spacer particles. At least one of the first inner limiting portions 142 and the first outer limiting portions 143 include the openings IO or OO that open toward the internal space IS and the outside and have the opening widths IOW or OOW are larger than the diameter of the spacer particles. Even if the excessive amount of the material is supplied during the formation of the sealing member 111j, the spacer particle in the excessive material is released to the internal space IS or the outside through the openings IO or OO because the opening width IOW or OOW of the openings IO or OO formed in at least one of the first inner limiting portions 142 and the first outer limiting portions 143 is larger than the diameter of the spacer particles. According to the configuration, the spacer particles are less likely to move over the first inner limiting portions 142 or the first outer limiting portions 143. Therefore, a distance (or a cell gap) between the first board and the second board is less likely to become uneven.

### Third Embodiment

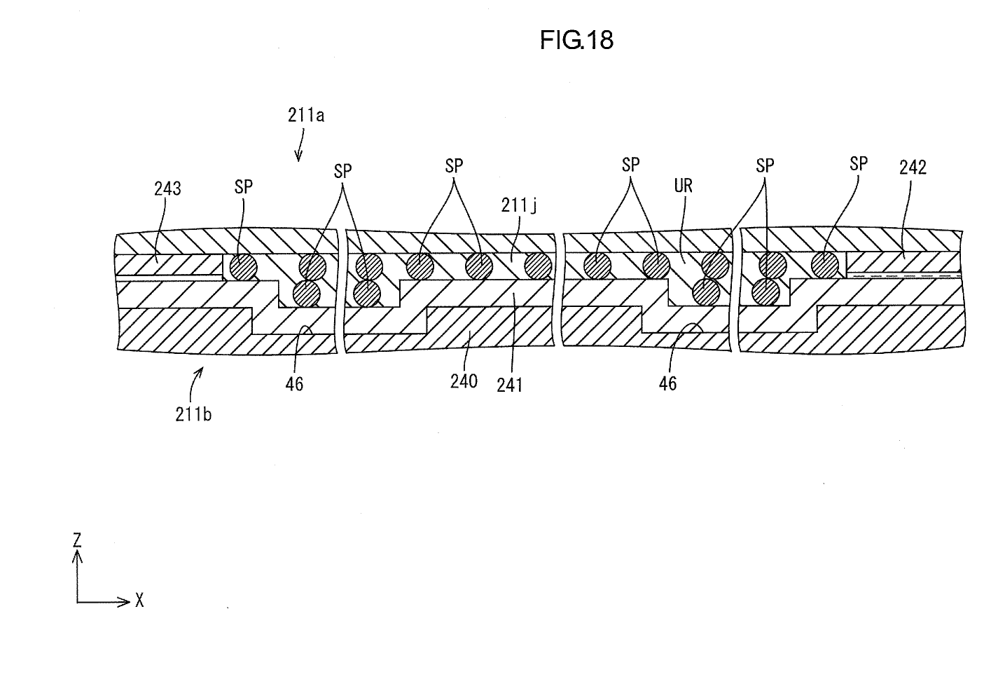

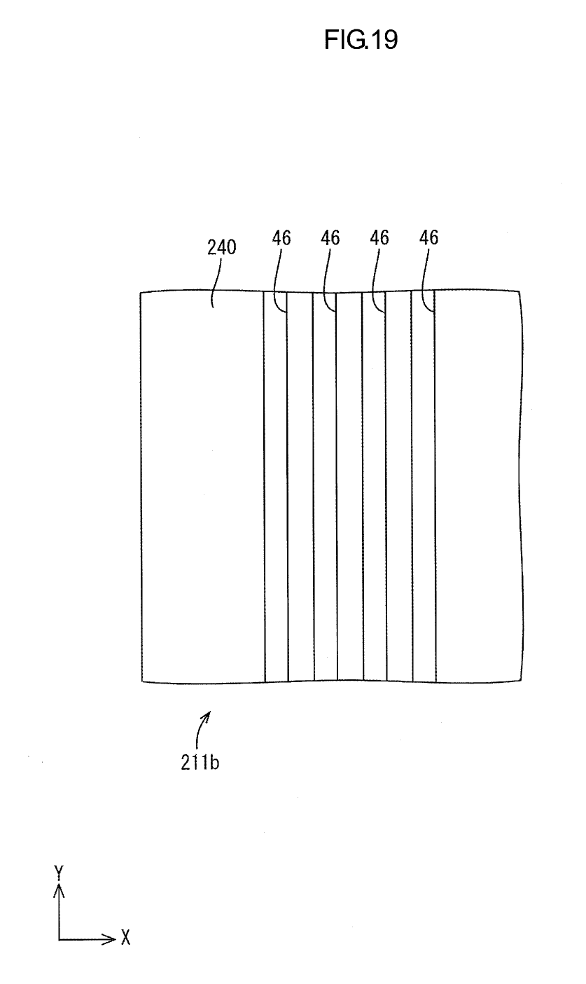

A third embodiment according to the present invention will be described with reference to FIG. 18 or 19. A difference between the first embodiment and the third embodiment is that the third embodiment includes an array board 211b including an organic insulator 240 with spacer holding grooves 46. Structures, functions, and effects similar to those of the first embodiment will not be described.

As illustrated in FIGS. 18 and 19, the organic insulator 240 included in the array board 211b according to this embodiment includes the spacer holding grooves 46 for holding spacer particle SP included in a material of a sealing member 211j. The spacer holding grooves 46 are formed in portions of the organic insulator 240 which in contact with the sealing member 211j. Each spacer holding groove 46 has a frame-like shape (a ring-like shape without an end) in a plan view and extends along the sealing member 211j. Four spacer holding grooves 46 are arranged parallel to one another in a width direction of the sealing member 211j. Each spacer holding groove 46 has a width larger than the diameter of the spacer particle SP and a depth about equal to the diameter of the spacer particle. Specifically, the spacer holding groove 46 has the width about 10 μm and the depth about 3 μm to 3.6 μm. During the formation of the sealing member 211j, the spacer particles SP in the excessive material of the sealing member 211j are released to the spacer holding grooves 46. According to the configuration, the spacer particles SP are less likely to move over the first inner limiting portion 242 or the first outer limiting portion 243 and thus a cell gap between the boards 211a and 211b is less likely to become uneven. Because the organic insulator 240 includes the spacer holing grooves 46, a second interlayer insulator 241 disposed in an upper layer is also includes groove portions formed along the spacer holding grooves 46.

As described above, the first inner limiting portions 242 and the first outer limiting portion 243 according to this embodiment are included in the CF board 211a that is one of the first board (the CF board 211a or the array board 211b) and the second board (the array board 211b or the CF board 211a). The sealing member 211j includes at least the ultraviolet curing resin UR and the spacer particles SP. The array board 211b that is the other one of the first board (the CF board 211a or the array board 211b) and the second board (the array board 211b or the CF board 211a) includes the spacer holding grooves 46 at the portions that are in contact with the sealing member 211j for holding the spacer particles SP. If the excessive amount of the material is supplied during the formation of the sealing member 211j, the spacer particles SP in the excessive material of the sealing member 211j are released to the spacer holding grooves 46. The spacer holding grooves 46 are formed in the portions of the array board 211b which are in contact with the sealing member 211j. The array board 211b is the board other than the CF board 211a that is one of the first board (the CF board 211a or the array board 211b) and the second board (the array board 211b or the CF board 211a) and includes the first inner limiting portions 242 and the first outer limiting portions 243. According to the configuration, the spacer particles SP are less likely to move over the first inner limiting portions 242 or the first outer limiting portions 243. Therefore, a distance (or a cell gap) between the first board (the CF board 211a or the array board 211b) and the second board (the array board 211b or the CF board 211a) is less likely to become uneven.

### Fourth Embodiment

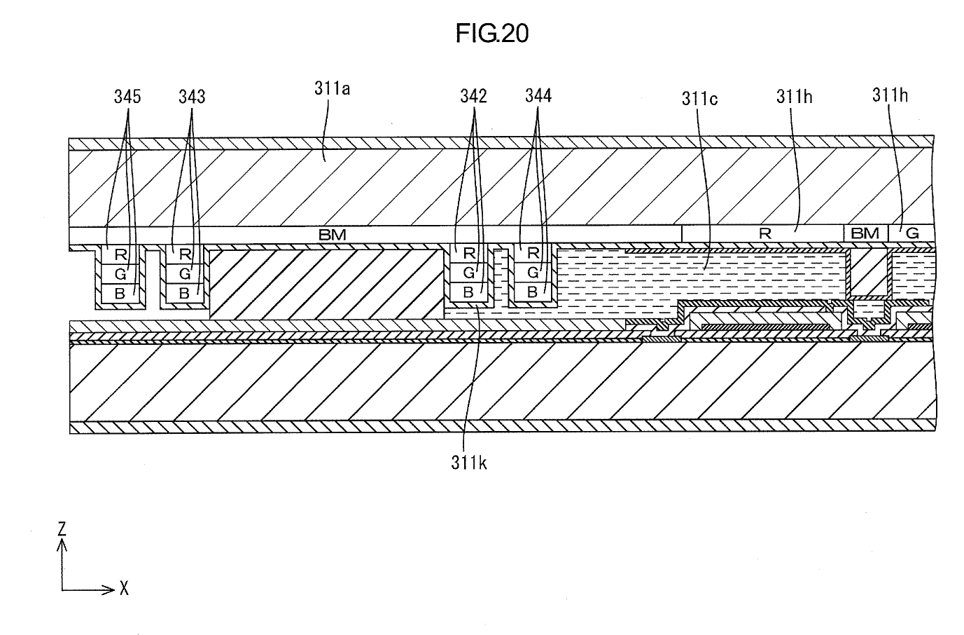

A fourth embodiment according to the present invention will be described with reference to FIG. 20. The fourth embodiment includes limiting portions 342 to 345 made of material different from the first embodiment. Structures, functions, and effects similar to those of the first embodiment will not be described.

As illustrated in FIG. 20, a first inner limiting portion 342, a first outer limiting portion 343, a second inner limiting portion 344, and a second inner limiting portion 345 are made of the same material as that of color filters 311h that are originally included in a CF board 311a and formed simultaneously with the color filters 311h in a step for forming the color filters 311h in the production process of the CF board 311a. Specifically, each of the first inner limiting portion 342, the first outer limiting portion 343, the second inner limiting portion 344, and the second inner limiting portion 345 includes red, green, and blue color portions that are components of the color filters 311h. The red, green, and blue color portions are layered at a forming position to achieve a sufficient height. According to the configuration, an extra step or material is not required for forming the first inner limiting portion 342, the first outer limiting portion 343, the second inner limiting portion 344, and the second inner limiting portion 345. This is advantageous for reducing the cost. In this configuration, the first inner limiting portion 342, the first outer limiting portion 343, the second inner limiting portion 344, and the second inner limiting portion 345 are arranged in a layer lower than an OC layer 311k (a glass substrate side, a side opposite from a liquid crystal layer 311c side).

### Fifth Embodiment

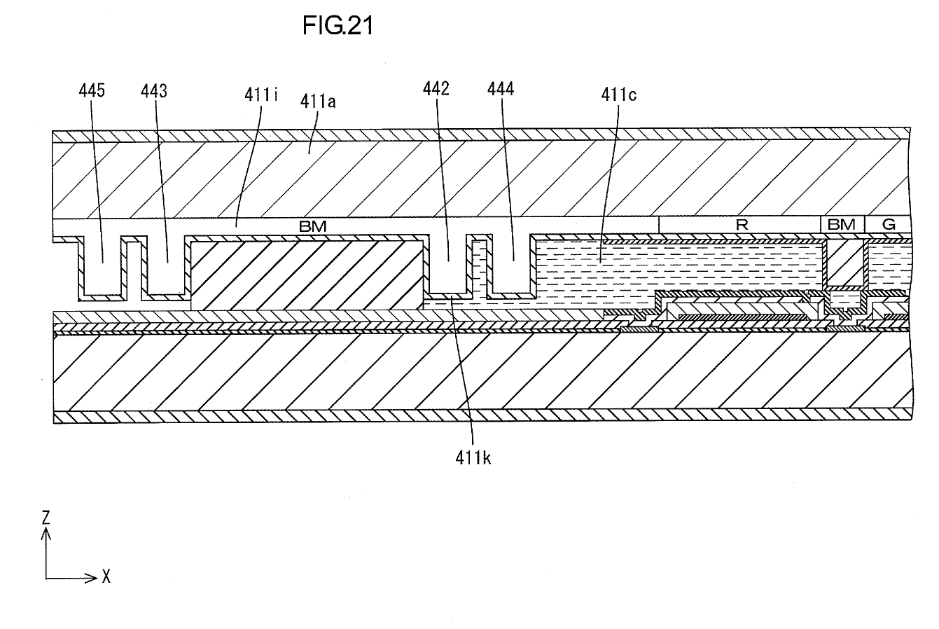

A fifth embodiment according to the present invention will be described with reference to FIG. 21. The fifth embodiment includes limiting portions 442 to 445 made of material different from the first embodiment. Structures, functions, and effects similar to those of the first embodiment will not be described.

As illustrated in FIG. 21, the first inner limiting portion 442, the first outer limiting portion 443, the second inner limiting portion 444, and the second outer limiting portion 445 are made of the same material as that of a light blocking layer 411i that is originally included in the CF board 411a and formed simultaneously with the light blocking layer 411i in a step for forming the light blocking layer 411i in a production process of the CF board 411a. Specifically, the first inner limiting portion 442, the first outer limiting portion 443, the second inner limiting portion 444, and the second outer limiting portion 445 are formed by thickening portions of the light blocking layer 411i at forming positions, respectively, such that they have a sufficient height. Therefore, an extra step or material for forming the first inner limiting portion 442, the first outer limiting portion 443, the second inner limiting portion 444, and the second outer limiting portion 445 is not required. This is advantageous for reducing the cost.

### Sixth Embodiment

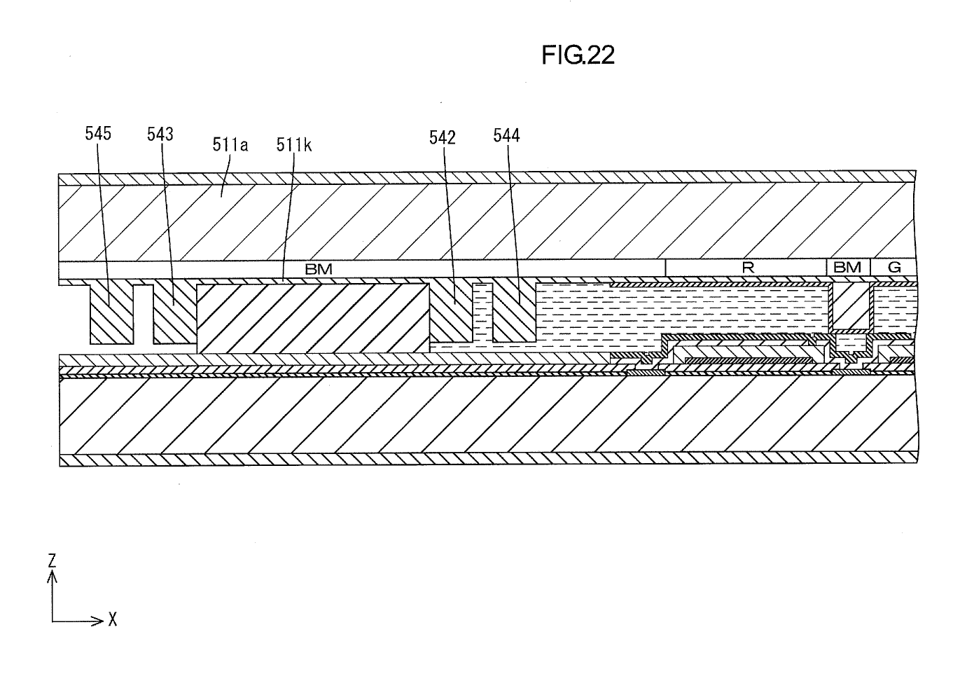

A sixth embodiment according to the present invention will be described with reference to FIG. 22. The sixth embodiment includes limiting portions 542 to 545 made of material different from the first embodiment. Structures, functions, and effects similar to those of the first embodiment described will not be described.

As illustrated in FIG. 22, the first inner limiting portion 542, the first outer limiting portion 543, the second inner limiting portion 544, and the second outer limiting portion 545 are made of the same material as that of an OC layer 511k that is originally included in a CF board 511a and formed simultaneously with the OC layer 511k in a step for forming the OC layer 511k in a production process of the CF board 511a. Specifically, the first inner limiting portion 542, the first outer limiting portion 543, the second inner limiting portion 544, and the second outer limiting portion 545 are formed by thickening portions of the OC layer 511k at forming positions, respectively, such that they have a sufficient height. Therefore, an extra step or a material for forming the first inner limiting portion 542, the first outer limiting portion 543, the second inner limiting portion 544, and the second outer limiting portion 545 is not required. This is advantageous for reducing the cost.

### Seventh Embodiment

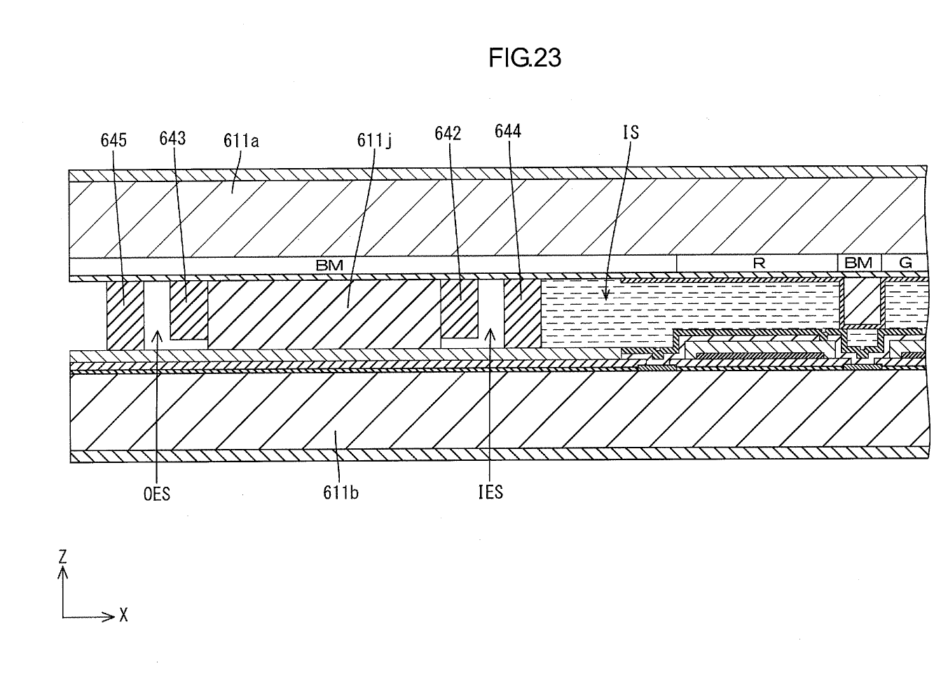

A seventh embodiment according to the present invention will be described with reference to FIG. 23. The seventh embodiment includes a second inner limiting portion 644 and a second outer limiting portion 645 having a height different from the first embodiment. Structure, functions, and effects similar to those of the first embodiment will not be described.

As illustrated in FIG. 23, the second inner limiting portion 644 and the second inner limiting portion 645 according to this embodiment have a height such that they are in contact with an array board 611b that is opposite to the second inner limiting portion 644 and the second inner limiting portion 645. Even if an excessive amount of the material is supplied to a CF board 611a during formation of the sealing member 611j, the excessive material is released to the inner escape space IES between a first inner limiting portion 642 and the second inner limiting portion 644 or the outer escape space OES between a first outer limiting portion 643 and the second outer limiting portion 645. According to the configuration described earlier, the such a material is less likely to enter the internal space IS that is located inner than the first inner limiting portion 643 or to leak out of the second outer limiting portion 645. To properly release the excessive material of the sealing member 611j, the inner escape space IES and the outer escape space OES need to have sufficient widths. Therefore, a distance between the first outer limiting portion 643 and the second outer limiting portion 645 and a distance between the first outer limiting portion 643 and the second outer limiting portion 645 are larger than those of the first embodiment.

### Eighth Embodiment

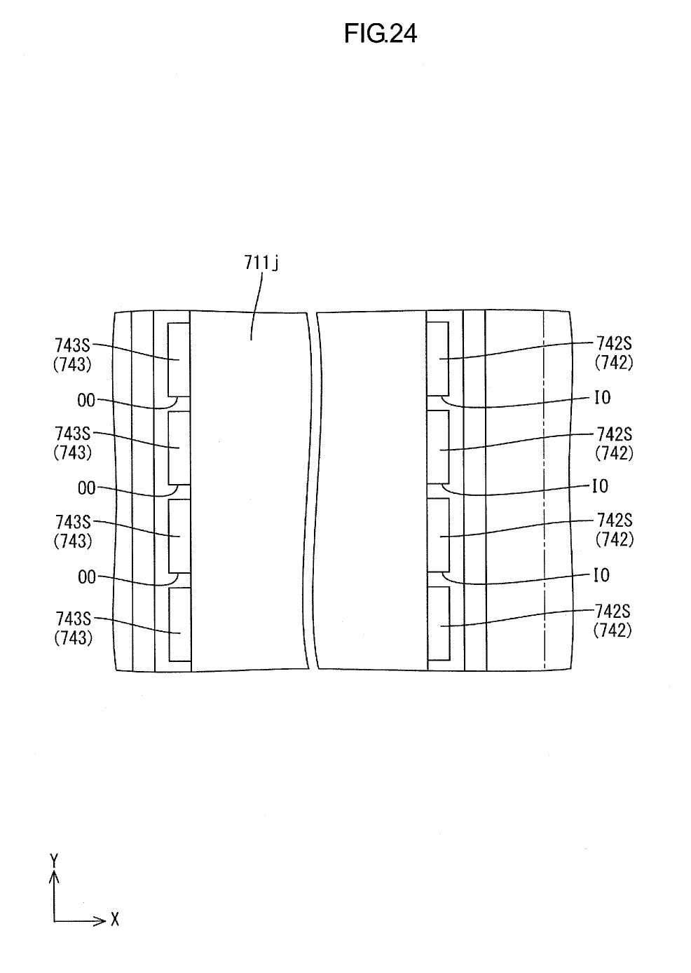

An eighth embodiment according to the present invention will be described with reference to FIG. 24. The eighth embodiment first inner limiting sections 742S and first outer limiting sections 743S (inner openings IO and outer openings OO) that are arranged differently from the second embodiment. Structures, functions, and effects similar to those of the second embodiment will not be described.

As illustrated in FIG. 24, the first inner limiting sections 724S and the first outer limiting sections 743S of first inner limiting portions 742 and first outer limiting portions 743 are arranged such that the inner openings IO and the outer openings 00 overlap with respect to a direction (the X-axis direction in FIG. 24) perpendicular to a direction (the Y-axis direction in FIG. 24) in which a sealing member 711j extends. The first inner limiting sections 724A and the first outer limiting portions 743S overlap one another for about the entire areas thereof with respect to the direction perpendicular to the direction in which the sealing member 711j extends.

### Ninth Embodiment

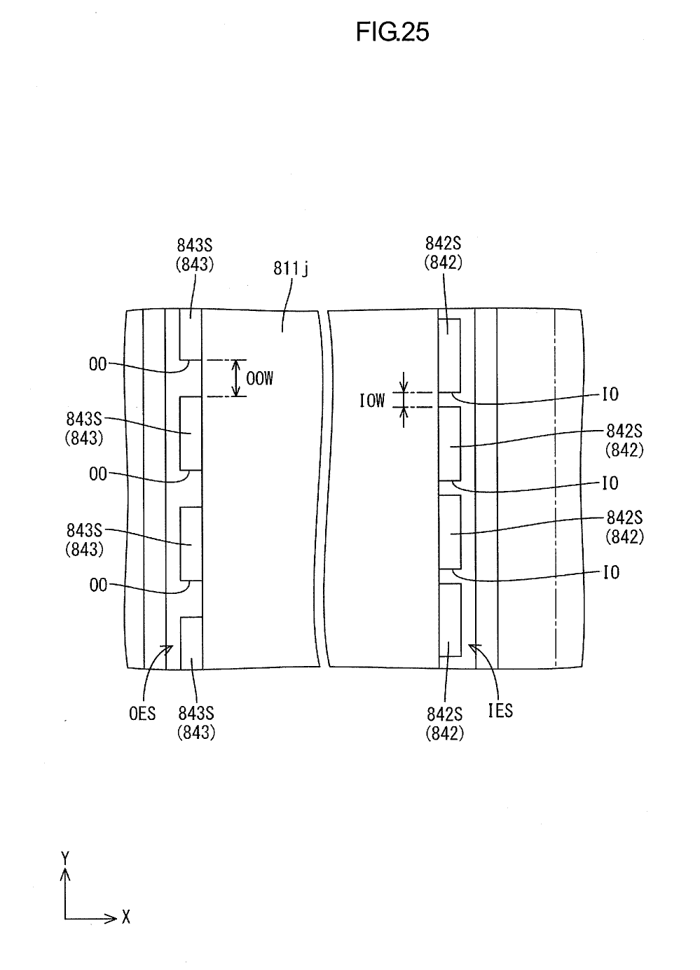

A ninth embodiment according to the present invention will be described with reference to FIG. 25. The ninth embodiment includes first outer limiting sections 843S arranged at different intervals from the second embodiment. Structures, functions, and effects similar to those of the second embodiment will not be described.

As illustrated in FIG. 25, first outer limiting portions 843 are formed such that an interval between the adjacent first outer limiting sections 843S is larger than an interval between adjacent first inner limiting sections 842S of first inner limiting portions 842. Namely, an opening width OOW of an outer opening OO of each first outer limiting portion 843 is larger than an opening width IOW of an inner opening IO of each first inner limiting portion 842. According to the configuration, if an excessive amount of material of a sealing member 811j is supplied, a larger amount of the excessive material is released to the outer escape space OES in comparison to the inner escape space IES.

### Tenth Embodiment

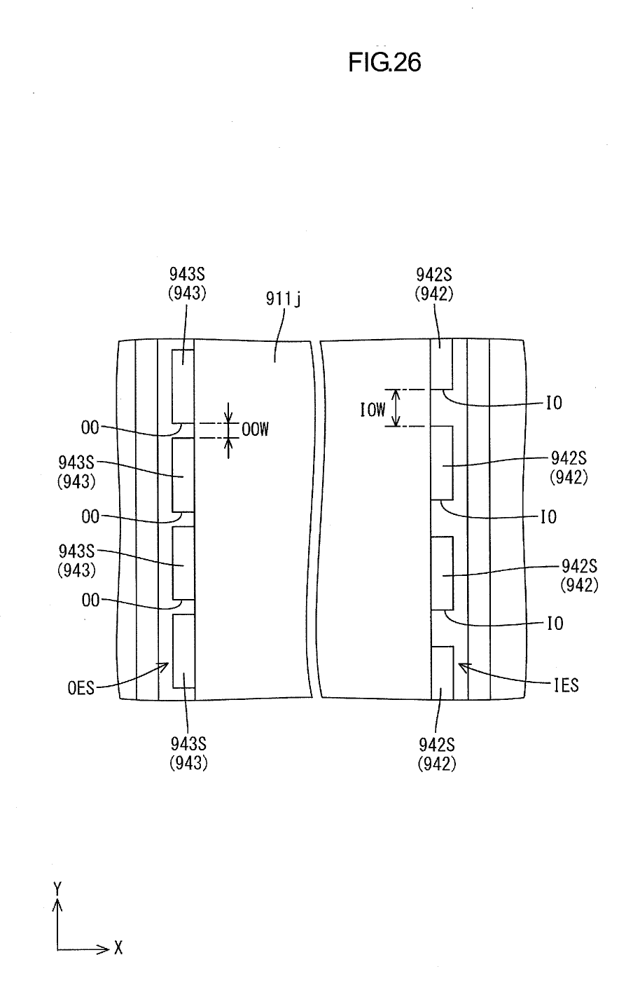

A tenth embodiment according to the present invention will be described with reference to FIG. 26. The tenth embodiment includes first inner limiting sections 942S arranged at different intervals from the second embodiment. Structures, functions, and effects similar to those of the second embodiment will not be described.

As illustrated in FIG. 26, first inner limiting portions 942 are formed such that an interval between the adjacent first inner limiting sections 942S is larger than an interval between adjacent first outer limiting sections 943S of first outer limiting portions 943. Namely, an opening width IOW of an inner opening IO of each first inner limiting portion 942 is larger than an opening width OOW of an outer opening OO of each first outer limiting portion 943. According to the configuration, if an excessive amount of material of a sealing member 911j is supplied, a larger amount of the excessive material is released to the inner escape space IES in comparison to the outer escape space OES.

### Eleventh Embodiment

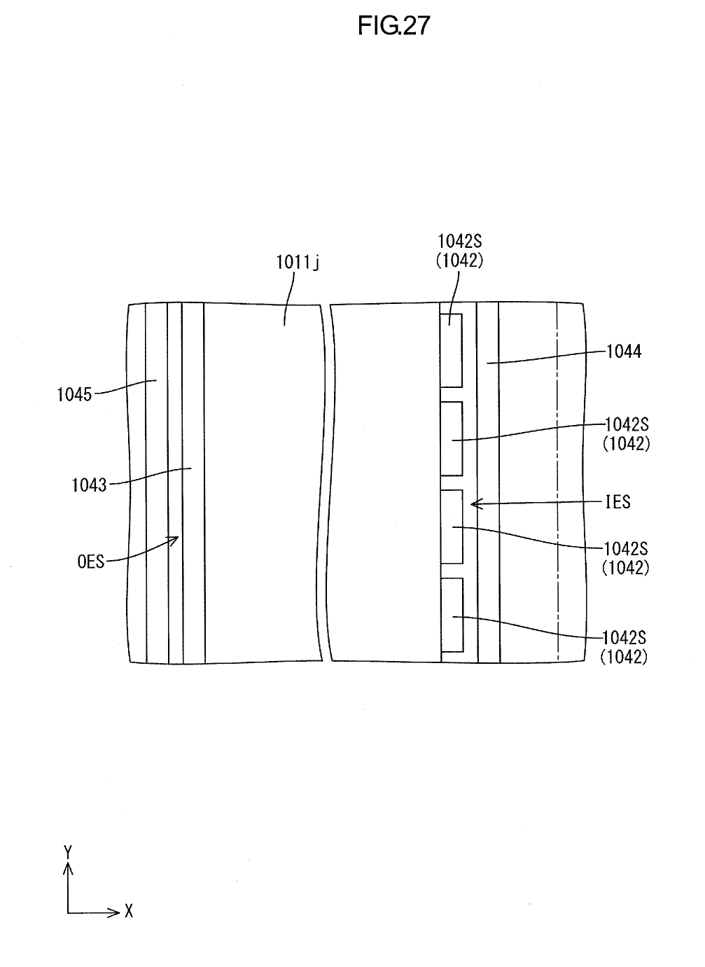

An eleventh embodiment according to the present invention will be described with reference to FIG. 27. The eleventh embodiment includes a first outer limiting portion 1043 that does not include divided sections. Structures, functions, and effects similar to those of the second embodiment will not be described.

As illustrated in FIG. 27, the first outer limiting potion 1043 according to this embodiment is arranged along a sealing member 1011j for the entire periphery of the sealing member 1011j similar to a second outer limiting portion 1045 and a second inner limiting portion 1044. The first outer limiting portion 1043 has a vertically-long frame-like shape (a ring-like shape without an end) in a plan view. In this embodiment, only first inner limiting portions 1042 includes divided sections, that is, first inner limiting sections 1042. According to the configuration, if an excessive amount of material of the sealing member 1011j is supplied, a larger amount of the excessive material is released to the inner escape space IES in comparison to the outer escape space OES.

### Twelfth Embodiment

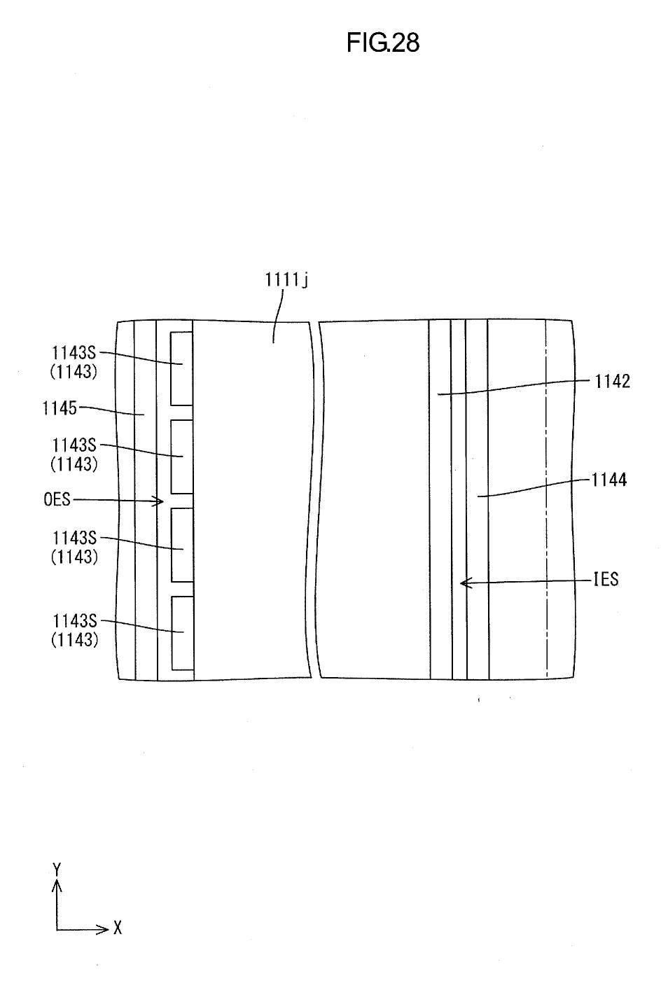

A twelfth embodiment according to the present invention will be described with reference to FIG. 28. The twelfth embodiment includes a first inner limiting portion 1142 that does not include divided sections. Structures, functions, and effects similar to those of the second embodiment will not be described.

As illustrated in FIG. 28, the first inner limiting potion 1142 according to this embodiment is arranged along a sealing member 1111j for the entire periphery of the sealing member 1111j similar to a second outer limiting portion 1145 and a second inner limiting portion 1144. The first inner limiting portion 1142 has a vertically-long frame-like shape (a ring-like shape without an end) in a plan view. In this embodiment, only first outer limiting portions 1143 includes divided sections, that is, first outer limiting sections 1143. According to the configuration, if an excessive amount of material of the sealing member 1111j is supplied, a larger amount of the excessive material is released to the outer escape space OES in comparison to the inner escape space IES.

### Thirteenth Embodiment

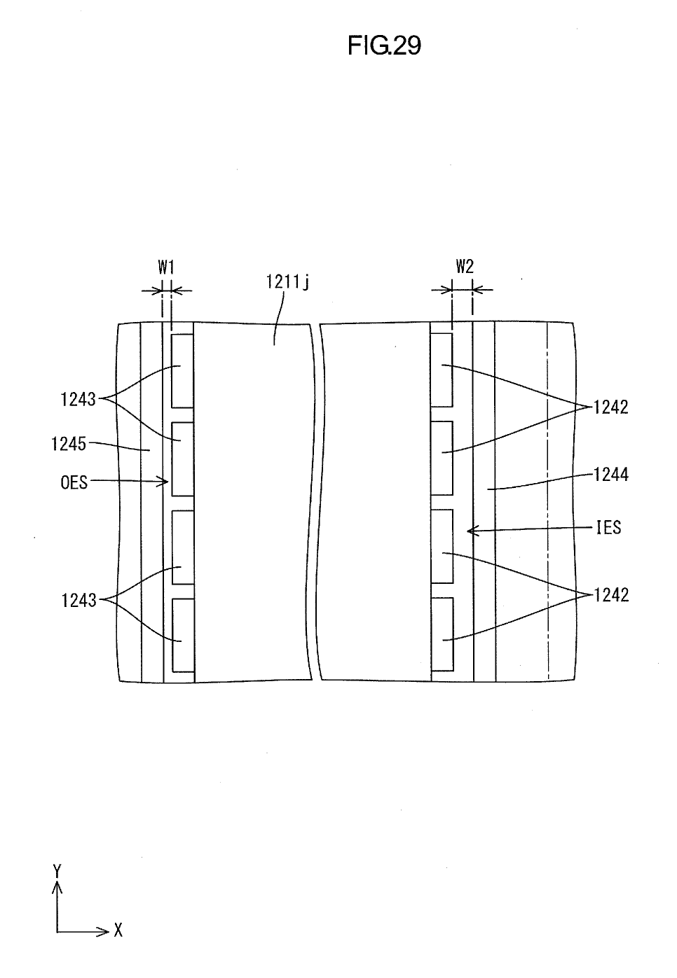

A thirteenth embodiment according to the present invention will be described with reference to FIG. 29. The thirteenth embodiment includes first outer limiting portions 1243 and a second outer limiting portion 1245 arranged such that a distance therebetween is different from the second embodiment. Structures, functions, and effects similar to those of the second embodiment will not be described.

As illustrated in FIG. 29, the first outer limiting portions 1243 and the second outer limiting portion 1245 are arranged such that a distance W1 between the first outer limiting portion 1243 and the second outer limiting portion 1245 is smaller than a distance W2 between a first inner limiting portion 1242 and a second inner limiting portion 1244. Namely, the outer escapes portion OES between the first outer limiting portion 1243 and the second outer limiting portion 1245 is smaller than the inner escape space IES between the first inner limiting portion 1242 and the second inner limiting portion 1244, that is, a capacity for receiving material of a sealing member 1211j is smaller.

### Fourteenth Embodiment

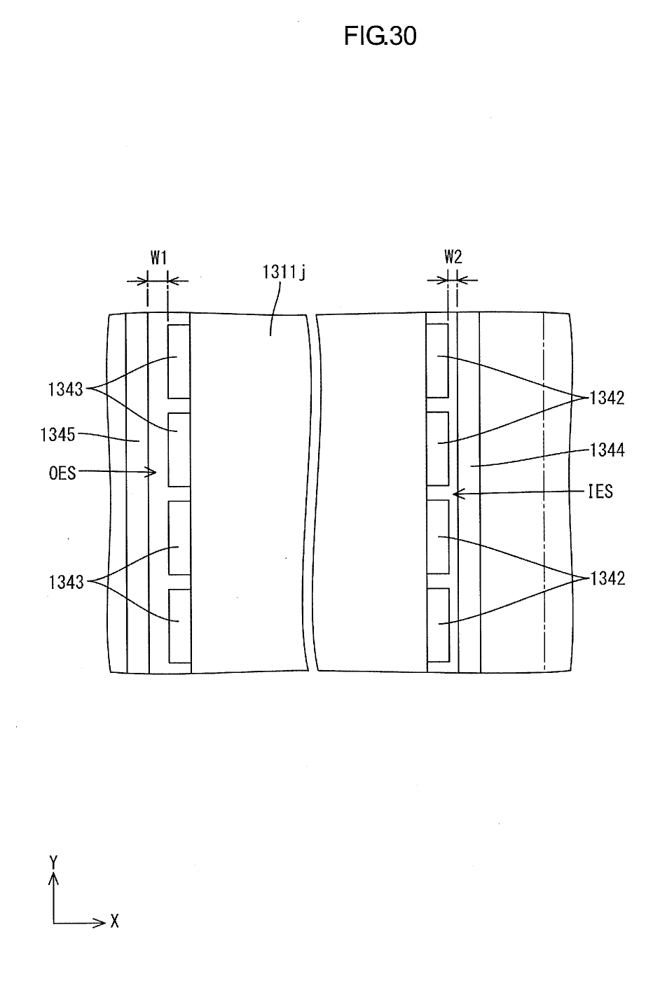

A fourteenth embodiment according to the present invention will be described with reference to FIG. 30. The fourteenth embodiment includes first inner limiting portions 1342 and a second inner limiting portion 1344 arranged such that a distance therebetween is different from the second embodiment. Structures, functions, and effects similar to those of the second embodiment will not be described.

As illustrated in FIG. 30, the first inner limiting portions 1342 and the second inner limiting portion 1344 are arranged such that a distance W2 between the first inner limiting portion 1342 and the second inner limiting portion 1344 is smaller than a distance W1 between a first outer limiting portion 1343 and a second outer limiting portion 1345. Namely, the inner escapes portion IES between the first inner limiting portion 1342 and the second inner limiting portion 1344 is smaller than the outer escape space OES between the first outer limiting portion 1343 and the second outer limiting portion 1345, that is, a capacity for receiving material of a sealing member 1311j is smaller.

### Fifteenth Embodiment

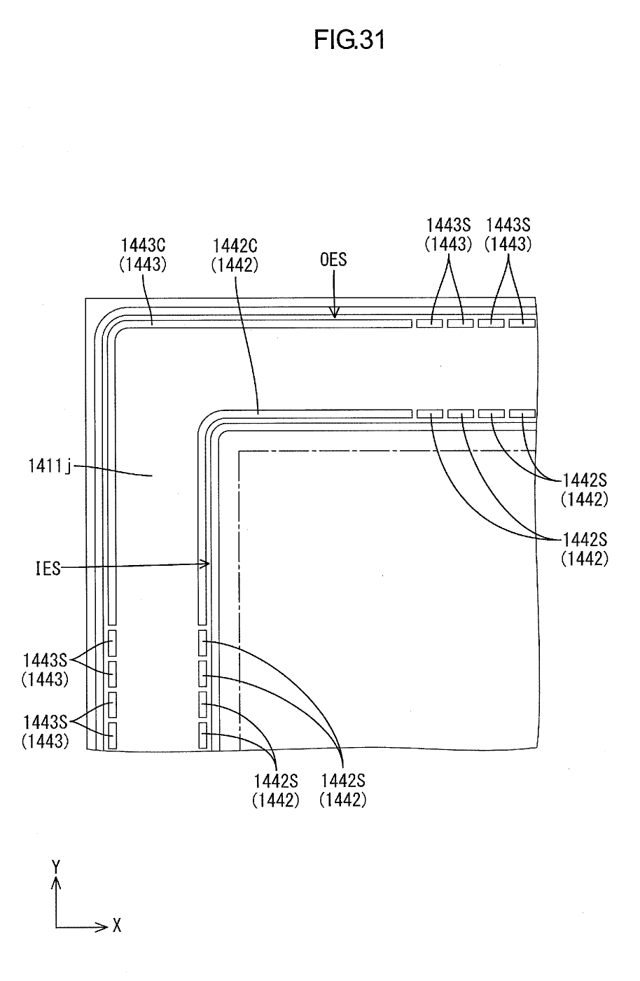

A fifteenth embodiment according to the present invention will be described with reference to FIG. 31. The fifteenth embodiment includes first inner limiting portions 1442 and first outer limiting portions 1443 that include divided sections. Structures, functions, and effects similar to those of the second embodiment will not be described.

As illustrated in FIG. 31, each of the first inner limiting portions 1442 and the first outer limiting portions 1443 has a frame-like overall shape along a sealing member 1411j in a plan view. Corners of the first inner limiting portions 1442 and the first outer limiting portions 1443 do not include divided sections. The first inner limiting portions 1442 include first corner inner limiting sections 1442C at four corners. The first outer limiting portions 1443 include first corner outer limiting sections 1443C. The first inner limiting portions 1442 and the first outer limiting portion 1443 include first inner limiting sections 1442S and first outer limiting sections 1443S, similar to the second embodiment, at four sides other than the corners thereof, respectively. Each of the first corner inner limiting sections 1442C and the first corner outer limiting sections 1443C has an L-like shape in a plan view. A creepage distance of the first corner inner limiting sections 1442C and that of the first corner outer limiting sections 1443C are larger than the length of the first inner limiting section 1442S and the first outer limiting section 1443S, respectively. According to the configuration, if an excessive amount of material of a sealing member 1411j is supplied during formation of the sealing member 1411j, the excessive material is less likely to be released to the inner escape space IES or the outer escape space OES from the corners but more likely to be released from the sides.

### Sixteenth Embodiment

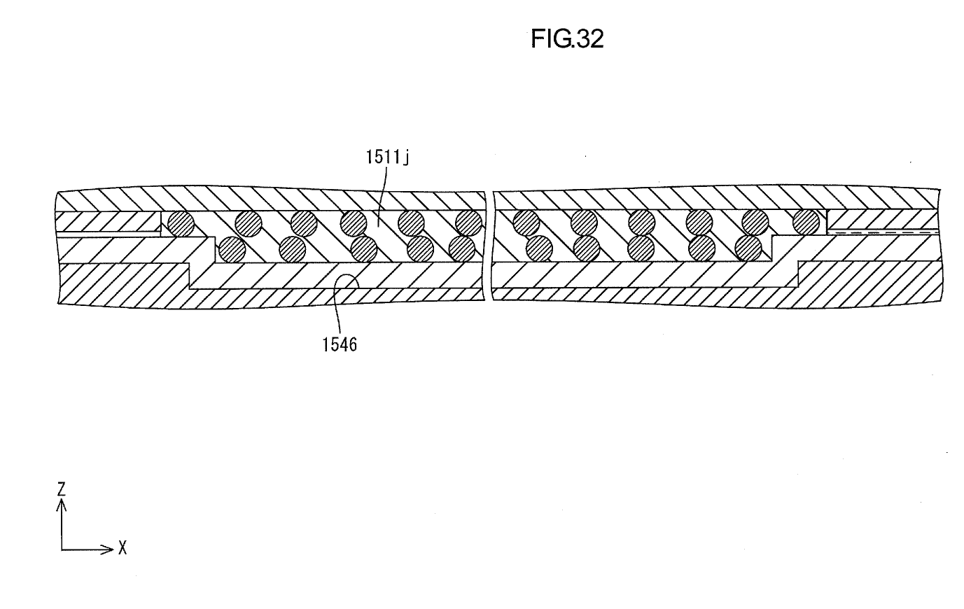

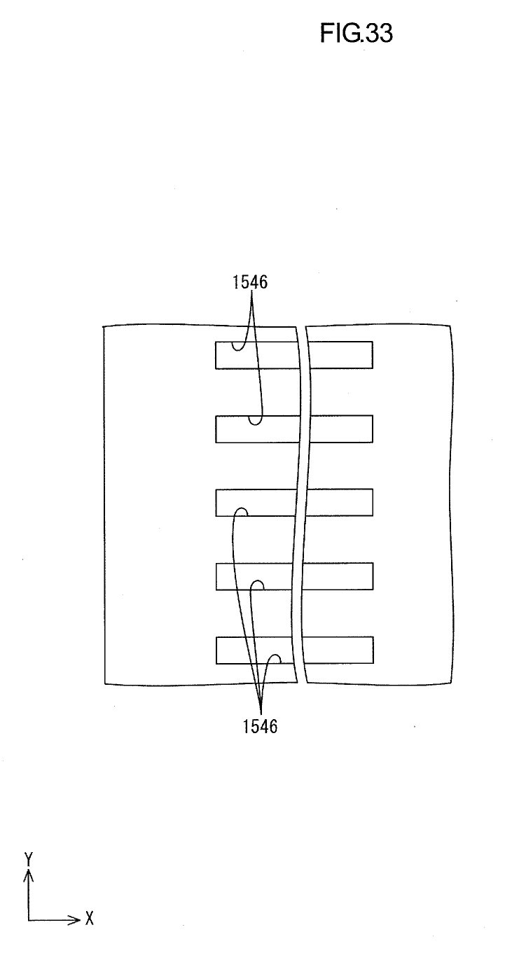

A sixteenth embodiment of the present invention will be described with reference to FIG. 32 or 33. The sixteenth embodiment includes spacer holding grooves 1546 having a configuration different from the third embodiment. Structures, functions, and effects similar to those of the third embodiment will not be described.

As illustrated in FIGS. 32 and 33, each of the spacer holding grooves 1546 extends along a width direction of the sealing member 1511j (a direction perpendicular to an extending direction in which the sealing member 1511j extends) and has a horizontally-long rectangular shape in a plan view. The spacer holding grooves 1546 are arranged parallel to one another along the extending direction in which the sealing member 1511j extends. Namely, the spacer holding grooves 1546 are arranged such that the extending direction and the width direction thereof are perpendicular to those of the spacer holding grooves 46 (see FIG. 19) in the third embodiment described earlier.

### Other Embodiment

The present invention is not limited to the above embodiments described with reference to the drawings. The following embodiments may be included in the technical scope of the present invention.

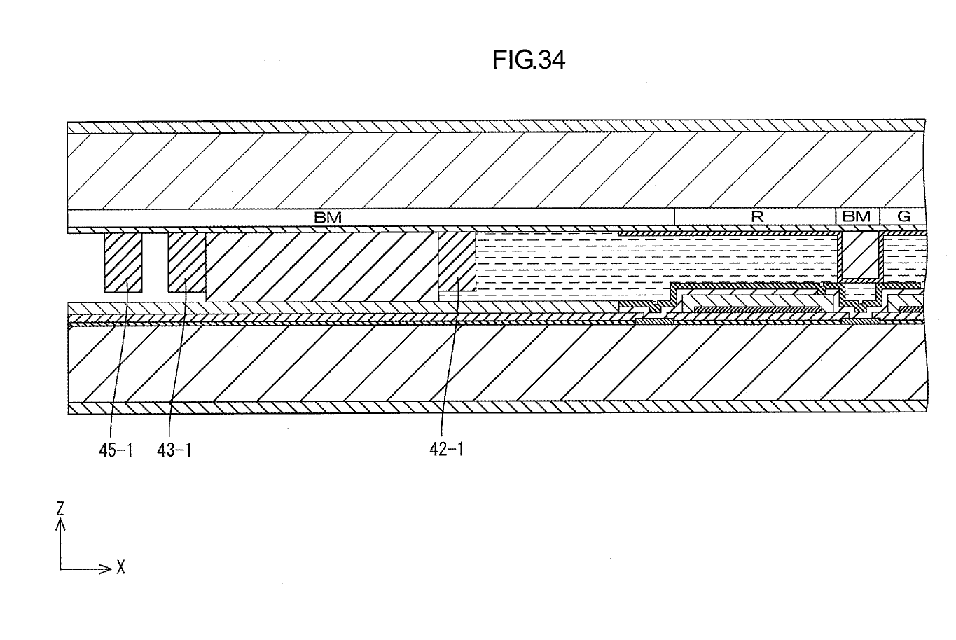

(1) A modification of the first embodiment may include a first inner limiting portion 42-1, a first outer limiting portion 42-2, and a second outer limiting portion 45-1 but not include the second inner limiting portion as illustrated in FIG. 34.

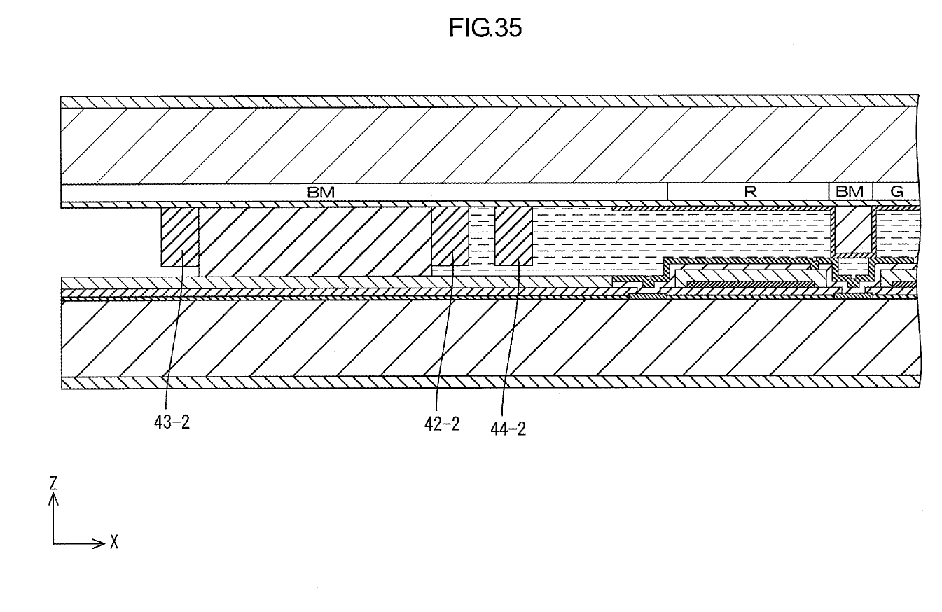

(2) A modification of the first embodiment may include a first inner limiting portion 42-2, a first outer limiting portion 43-2, and a second inner limiting portion 44-2 but not include the second outer limiting portion as illustrated in FIG. 35.

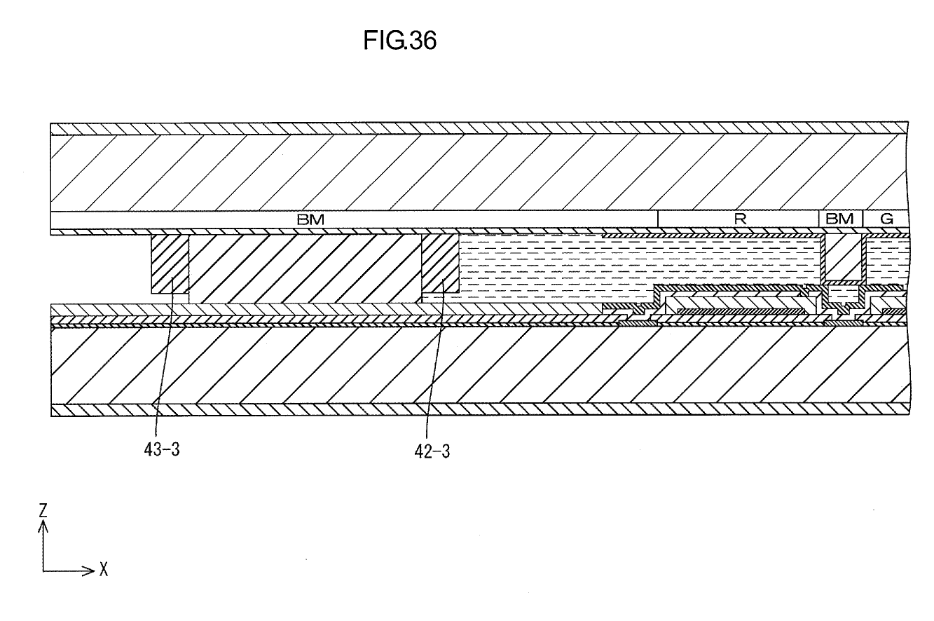

(3) A modification of the first embodiment may include a first inner limiting portion 42-3 and a first outer limiting portion 43-3 but not include the second inner limiting portion and the second outer limiting portion as illustrated in FIG. 36.

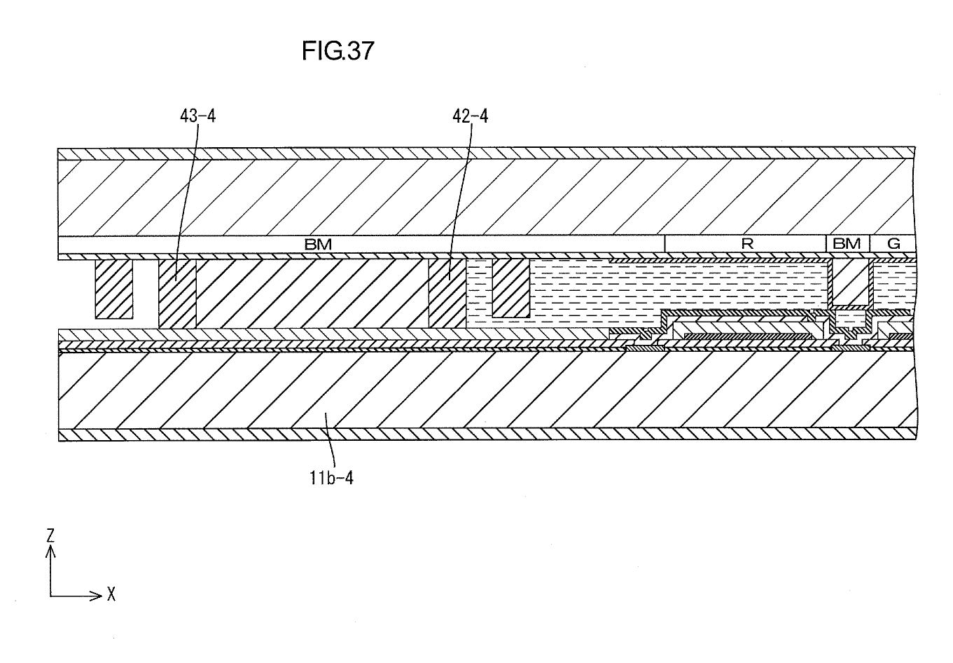

(4) A modification of the second embodiment may include a first inner limiting portion 42-4 and a first outer limiting portion 43-4 having a height such that they are in contact with an array board 11b-4 as illustrated in FIG. 37.

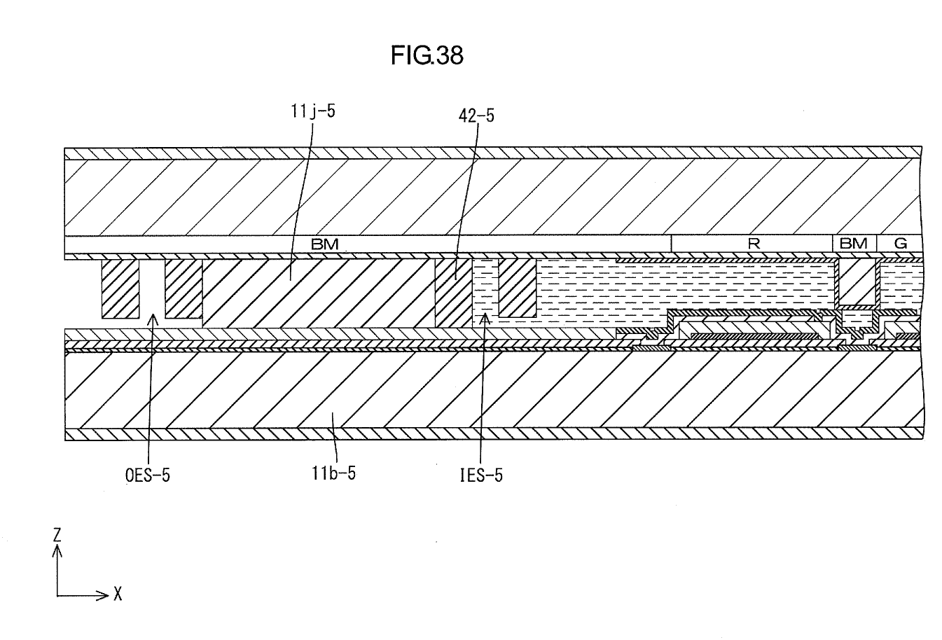

(5) A modification of the second embodiment may include a first inner limiting portion 42-5 that only has a height such that it is in contact with an array board 11b-5 as illustrated in FIG. 38. According to the configuration, if an excessive amount of material of a sealing member 11j-5 is supplied, a larger amount of the excessive material is released to outer escape space OES-5 in comparison to the inner escape space IES-5.

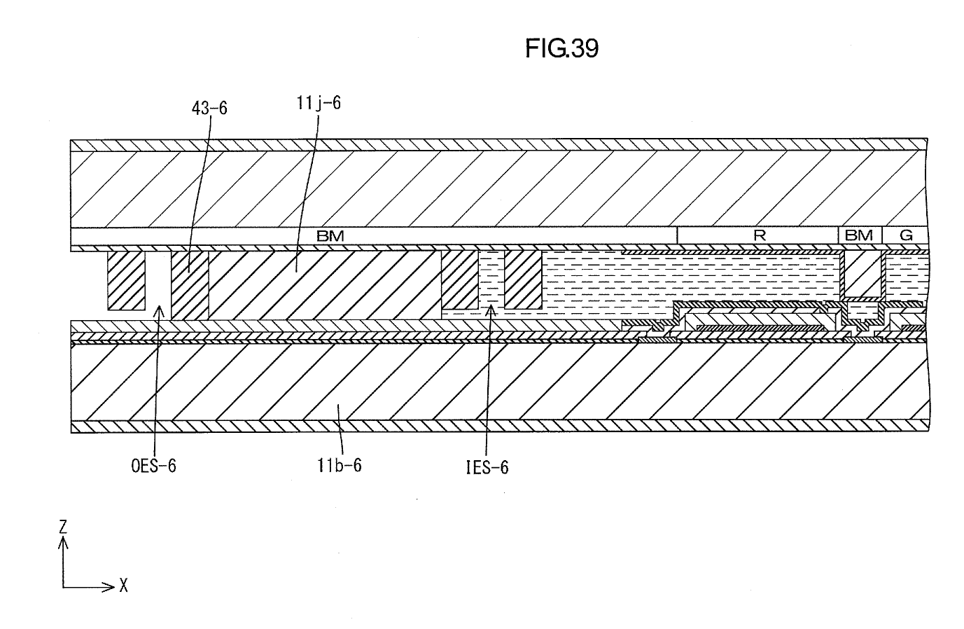

(6) A modification of the second embodiment may include a first outer limiting portion 43-6 that only has a height such that it is in contact with an array board 11b-6 as illustrated in FIG. 39. According to the configuration, if an excessive amount of material of a sealing member 11j-6 is supplied, a larger amount of the excessive material is released to inner escape space IES-6 in comparison to the outer escape space OES-6.

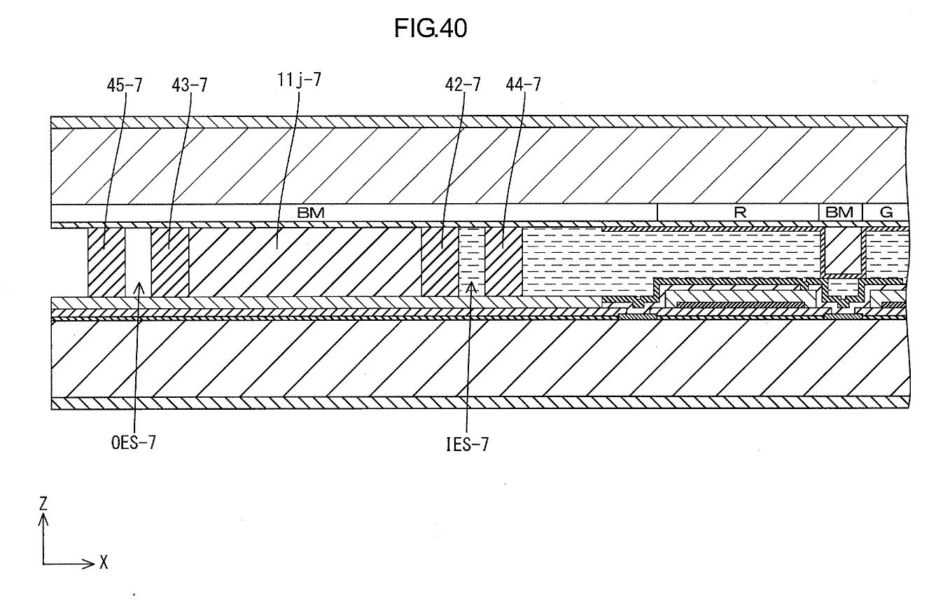

(7) A modification of the second embodiment may include limiting portions 42-7 to 45-7 that are all in contact with an array board 11b-7 as illustrated in FIG. 40. According to the configuration, if an excessive amount of material of a sealing member 11j-7 is supplied, the excessive material is released to inner escape space IES-7 through the opening of the first inner limiting portion 42-7 or outer escape space OES-7 through the opening of the first outer limiting portion 43-7.

(8) The above configurations (1) to (3) may be applied to the second and the third embodiments.

(9) The above configurations (4) to (7) may be applied to the first and the third embodiments.

(10) In each of the above embodiments, the second inner limiting portion is on inner than the first inner limiting portion and the second outer limiting portion is on outer than the first outer limiting portion. A third inner limiting portion may be formed at a position further inner than the second inner limiting portion and a distance from the second inner limiting portion. A third outer limiting portion may be formed at a position further outer than the second outer limiting portion and a distance from the second outer limiting portion. Another limiting portion may be added at a position inner than the third inner limiting portion or another limiting portion may be added at a position outer than the third outer limiting portion.

(11) In each of the above embodiments, all the limiting portions (the first inner limiting portion, the first outer limiting portion, the second inner limiting portion, and the second outer limiting portion) are included in the CF board. At least one of the first inner limiting portion, the first outer limiting portion, the second inner limiting portion, and the second outer limiting portion may be included in the array board. If the first inner limiting portion and the first outer limiting portion are included in the array board, it is preferable to apply the material of the sealing member to the array board in the sealing member forming process. All the limiting portions may be included in the array board. In this case, it is preferable to apply the material of the sealing member to the array board.

(12) Other than the above (11), at least one of the first inner limiting portion, the first outer limiting portion, the second inner limiting portion, and the second outer limiting portion may be included in each of the array board and the CF board.

(13) The sealing member forming area (the width, the sealing width), the widths of the first inner limiting portion, the first outer limiting portion, the second inner limiting portion, and the second outer limiting portion, the distance between the first inner limiting portion and the second inner limiting portion, the distance between the first outer limiting portion and the second outer limiting portion, the cell gap size, and the diameter of the spacer particle may be altered from those of the above embodiments as appropriate.

(14) The lengths or intervals (or the opening widths of the openings) of the first inner limiting sections and the first outer limiting sections may be altered from those of the second embodiment as appropriate.

(15) The width and the depth of the spacer holding groove may be altered from those of the third embodiment.

(16) In each of the above embodiments, the material of the sealing member contains the ultraviolet curing resin. However, other type of curing resin may be used. For example, a light curing resin that is hardened with visible light or a thermosetting resin that is hardened with heat may be used. In any cases, it is preferable to contain spacer particles.

(17) In each of the above embodiments, the material of the sealing member includes the spacer particles. However, a material only containing a curing resin, that is, without the spacer particles may be used.

(18) The fourth to the seventh embodiments may be applied to the second and the third embodiments.

(19) The second and the eighth to the fifteenth embodiment may be applied to the third embodiment.

(20) The sixteenth embodiment may be applied to the second embodiment.

(21) In each of the above embodiments, the spacers disposed in the display area are the photo spacers. The spacers may include spherical spacers dispersed within the display area.

(22) The production method using the mother glasses from which nine CF boards and nine array boards are prepared is described. The number of boards prepared from a single mother glass may be altered as appropriate. A production method not using a mother glass may be used.

(23) A row control circuit for supplying output signals from the driver to the gate lines or a column control circuit for supplying output signals from the driver to the source lines may be disposed in the non-display area of the array board. The row control circuit and the column control circuit may be monolithically fabricated on the array board as the semiconductor oxide as a base. The semiconductor oxide is a material for the semiconductor film of the TFT. The row control circuit and the column control circuit include control circuit for controlling supply of the output signals to the TFTs, respectively. The row control circuit and the column control circuit are formed by patterning simultaneously on the array board by a known photolithography during the patterning of the TFTs in the production process of the array board. Specifically, the column control circuit may include a switching circuit (an RGB switching circuit) for distributing image signals in the output signals from the driver to the source lines. The row control circuit may further include an accessary circuit such as a level shifter circuit and an ESD protection circuit. The column control circuit may include a scanning circuit for supplying scanning signals in the output signals from the driver at predetermined timing for scanning the gate lines in sequence. The column control circuit may further include an accessary circuit such as a level shifter circuit and an ESD protection circuit.

(24) In the above embodiments, the oxide semiconductor film is the oxide thin film containing indium (In), gallium (Ga), and zinc (Zn). However, another kind of oxide semiconductor material may be used. Specifically, an oxide containing indium (In), silicon (Si), and zinc (Zn), an oxide containing indium (In), aluminum (Al), and zinc (Zn), an oxide containing tin (Sn), silicon (Si), and zinc (Zn), an oxide containing tin (Sn), aluminum (Al), and zinc (Zn), an oxide containing tin (Sn), gallium (Ga), and zinc (Zn), an oxide containing gallium (Ga), silicon (Si), and zinc (Zn), an oxide containing gallium (Ga), aluminum (Al), and zinc (Zn), an oxide containing indium (In), copper (Cu), and zinc (Zn), an oxide containing tin (Sn), copper (Cu), and zinc (Zn) may be used.

(25) The first metal film and the second metal film are formed from a multilayer film of titanium (Ti) and copper (Cu) in the above embodiments. However, titanium may be replaced by molybdenum (Mo), molybdenum nitride (MoN), titanium nitride (TiN), tungsten (W), niobium (Nb), molybdenum-titanium alloy (MoTi), or molybdenum-tungsten alloy (MoW). Alternatively, a single-layer metal film of titanium, copper, or aluminum may be used.

(26) In each of the above embodiments, the liquid crystal panel includes the FFS mode as an operation mode. However, a liquid crystal panel including the IPS (In-Plane Switching) mode or the VA (Vertical Alignment) mode as an operation mode may be included in the scope of the present invention. If the liquid crystal panel includes the VA mode as an operation mode, a common electrode may be included in the CF board rather than the array board and may not include the OC layer.

(27) In each of the above embodiments, polyimide is used for the material of the alignment film. However, other type of liquid crystal alignment material may be used for the material of the alignment film.

(28) In each of the above embodiments, the photo alignment material is used for the material of the alignment film and the photo alignment film for performing alignment with application of ultraviolet rays is formed. An alignment film for performing alignment with rubbing may be included in the scope of the present invention.

(29) In each of the above embodiments, the display area on the liquid crystal panel is in the middle of the short dimension and off to one end of the long dimension. However, a liquid crystal panel including a display area in the middle of the long dimension and off to one end of the short dimension may be included in the scope of the present invention. Furthermore, a liquid crystal panel including a display area off to one end of the long dimension and to one end of the short dimension may be included in the scope of the present invention. Furthermore, a liquid crystal panel including a display area in the middle of the long dimension and in the middle of the short dimension may be included in the scope of the present invention.

(30) The driver is mounted directly on the array board by the COG method in the above embodiments. However, the driver mounted on the flexible printed circuit board connected to the array board through ACF may be included in the scope of the present invention.

(31) Each of the embodiments includes the liquid crystal panel having a vertically-long rectangular shape. However, a liquid crystal panel having a horizontally-long rectangular shape or a square shape may be included in the scope of the present invention.

(32) A configuration including the liquid crystal panel in each of the above embodiments and a functional panel such as a touch panel or a parallax barrier panel (switch liquid crystal panel) attached to the liquid crystal panel may be included in the scope of the present invention. Furthermore, a configuration including a touch panel pattern directly formed on a liquid crystal panel may be included in the scope of the present invention.

(33) The backlight device in the liquid crystal display device is the edge-light type in the above embodiments. However, a liquid crystal display device including a direct backlight device may be included in the scope of the present invention.

(34) Each of the above embodiments includes the transmissive type liquid crystal display device including the backlight device as an external light source. However, a reflective liquid crystal display device configured to display images using external light may be included in the scope of the present invention. Such a display device does not require a backlight device.

(35) Each of the above embodiments includes the TFTs as switching components of the liquid crystal display device. However, switching components other than the TFTs (such as thin film diodes (TFDs)) may be included in the scope of the present invention. Furthermore, a liquid crystal display device configured to display black and white images other than o the liquid crystal display device configured to display color images.

(36) Each of the above embodiments includes the liquid crystal panel including the liquid crystals held between the boards. However, a display panel including functional organic molecules other than the liquid crystals other than the liquid crystals held between the boards may be included in the scope of the present invention.

(37) In each of the above embodiments, the liquid crystal panel is used for the display panel. A PDP (plasma display panel) or an organic EL panel may be included in the scope of the present invention. In the DPD or the organic EL panel, if the sealing member forming area is not stable, the moisture is more likely to enter from the outside to the internal space through the wide portion of the sealing member. Therefore, similarly to the above embodiments, problems including a decrease in display quality may occur. Such problems can be solved by the technology of the present invention.

(38) The above embodiments include the liquid crystal panels that are classified as small sized or small to middle sized panels. Such liquid crystal panels are used in electronic devices including PDAs, mobile phones, laptop computers, digital photo frames, portable video games, and electronic ink papers. However, liquid crystal panels that are classified as middle sized or large sized (or supersized) panels having screen sizes from 20 inches to 90 inches are also included in the scope of the present invention. Such display panels may be used in electronic devices including television devices, electronic signboards (digital signage), and electronic blackboard.

### EXPLANATION OF SYMBOLS

11: Liquid crystal panel (a display device)
11a, 211a, 311a, 411a, 511a, 611a: CF board (a first board or a second board, one of the boards)
11b, 211b, 611b: Array board (a first board or a second board, another one of the boards)
11c, 311c, 411c: Liquid crystal layer (liquid crystals)
11h, 311h: Color filter
11i, 411i: Light blocking layer (a light blocking portion)
11j, 111j, 211j, 611j, 711j, 811j, 911j, 1011j, 1111j, 1211j, 1311j, 1411j, 1511j: Sealing member
111: Spacer
17: TFT (a switching component)
18: Pixel electrode
36: Semiconductor film
42, 142, 242, 342, 442, 542, 642, 742, 842, 942, 1042, 1142, 1242, 1342, 1442: First inner limiting portion (an inner limiting portion)
43, 143, 243, 343, 443, 543, 643, 743, 843, 943, 1043, 1143, 1243, 1343, 1443: First outer limiting portion (an outer limiting portion)
44, 144, 344, 444, 544, 644, 1044, 1144, 1244, 1344: Second inner limiting portion (a second inner limiting portion)
45, 145, 345, 445, 545, 645, 1045, 1145, 1245, 1345: Second outer limiting portion (a second outer limiting portion)
46, 1546: Spacer holding groove
C1: First gap (a gap)
C2: Second gap (a gap)
IO: Inner opening (an opening)
IOW: Opening width
IS: Internal space
OO: Outer opening (an opening)
OOW: Opening width
SP: Spacer particle
UR: Ultraviolet curing resin (a curing resin)

1. A display panel comprising:
a first board;
a second board disposed opposite the first board with internal space between the first board and the second board;
a sealing member disposed between the first board and the second board so as to surround the internal space and sealing the internal space;
an inner limiting portion included in at least one of the first board and the second board, located closer to the internal space than the sealing member, and for limiting a forming area of the sealing member from an internal space side; and
an outer limiting portion included in at least one of the first board and the second board, located on an outer side farther from the internal space than the sealing member, and for limiting the sealing member forming area from the outer side.

2. The display panel according to claim 1, wherein the inner limiting portion and the outer limiting portion are arranged so as to be in contact with the sealing member.

3. The display panel according to claim 1 or 2, further comprising at least one of:
a second inner limiting portion included in at least one of the first board and the second board on the internal space side and located in a distance from the inner limiting portion; and
a second outer limiting portion included in at least one of the first board and the second board on the outer side in a distance from the outer limiting portion.

4. The display panel according to claim 3, wherein at least one of the second inner limiting portion and the second outer limiting portion is arranged parallel to the sealing member for an entire periphery of the sealing member.

5. The display panel according to claim 3, wherein at least one of the inner limiting portion and the outer limiting portion including sections arranged at intervals in a peripheral direction of the sealing member.

6. The display panel according to claim 5, wherein
the sealing member contains at least a curing resin and spacer particles, and
at least one of the inner limiting portion and the outer limiting portion includes an opening that opens toward the internal space and the outer side and has an opening width larger than a diameter of the spacer particles.

7. The display panel according to claim 3, wherein at least one of the inner limiting portion and the outer limiting portion is included in one of the first board and the second board such that a gap is provide between the at least one of the inner limiting portion and the outer limiting portion and another one of the boards.

8. The display panel according to claim 5, wherein at least one of the second inner limiting portion and the second outer limiting potion is included in at least one of the first board and the second board such that a gap is provided between the at least one of the second inner limiting portion and the second outer limiting potion and another one of the boards.

9. The display panel according to claim 1, wherein
at least one of the first board and the second board includes at least:
a color filter including a plurality of color portions;
a light blocking portion arranged between the adjacent color portions; and
a spacer for defining a distance between the at least one of the first board and the second board and the other one of the first board and the second board, and
the inner limiting portion and the outer limiting portion are included in the one of the boards and made of same material as that of at least one of the color filter, the light blocking portion, and the spacer.

10. The display panel according to claim 1, wherein
the inner limiting portion and the outer limiting portion is included in one of the first board and the second board,
the sealing member contains at least a curing resin and spacer particles, and
the other one of the first board and the second board includes a spacer holing groove for holing the spacer particles therein at a portion that is in contact with the sealing member.

11. The display panel according to claim 1, wherein any one of the first board and the second board includes at least a switching component that uses an oxide semiconductor as a semiconductor film and a pixel electrode connected to the switching component.

12. The display panel according to claim 11, wherein the oxide semiconductor contains indium (In), gallium (Ga), zinc (Zn), and oxygen (O) as base components.

13. The display panel according to claim 1, further comprising liquid crystals in the internal space between the first board and the second board.

14. A method of producing a display panel comprising:
a limiting portion forming process for forming an inner limiting portion in any one of a first board and a second board closer to an internal space and an outer limiting portion on an outer side farther from the internal space;
a sealing member forming process for forming a sealing member between the inner limiting portion and the outer limiting portion on the one of the boards; and
a bonding process for bonding another one of the first board and the second board opposite the one of the boards to the one of the boards with the internal space therebetween.

15. The method according to claim 14, wherein the sealing portion forming process includes supplying a material of the sealing member to the one of the boards at an amount such that a forming area of the sealing member is larger than a distance between the inner limiting portion and the outer limiting portion.
